(19) United States
(12) Patent Application Publication
(10) Pub. No.: US 2024/0346640 A1
(43) Pub. Date: Oct. 17, 2024

(54) DAMAGE ASSESSMENT FOR VEHICLES

(71) Applicant: OLA ELECTRIC MOBILITY LIMITED, Bangalore (IN)

(72) Inventors: Hitesh HINDUJA, Bangalore (IN); Gaurav AGARWAL, Bengaluru (IN); Abhishek TRIVEDI, Kanpur (IN); Mohammad AHMAD, Delhi (IN)

(21) Appl. No.: 18/699,263

(22) PCT Filed: Oct. 7, 2022
(86) PCT No.: PCT/IN2022/050905

§ 371 Date: Apr. 5, 2024

(30) Foreign Application Priority Data
Oct. 8, 2021 (IN) 202141045914

(51) Int. Cl. G06T 7/00; G05B 23/02; G06V 10/25; G06V 10/62; G06V 10/764

(52) U.S. Cl. CPC G06T 7/0004; G05B 23/0283; G06V 10/25; G06V 10/62; G06V 10/764; G06T 2207/20081; G06T 2207/30252

(57) ABSTRACT

A damage assessment method is provided. The method comprises recognizing a region of interest in an image that corresponds to a visible damage inflicted on a target object. The method further comprises determining a first plurality of feature values for a plurality of image features based on the recognized region of interest. The method further comprises retrieving, from a memory, time-series information that indicates a usage pattern of the target object and determining a second plurality of feature values for a plurality of usage features based on the retrieved time-series information. The method further comprises providing the first plurality of feature values and the second plurality of feature values as input to a trained classifier and predicting a true age of the visible damage based on a classification output of the trained classifier for the first plurality of feature values and the second plurality of feature values.

### BACKGROUND

### Field of the Disclosure

Various embodiments of the disclosure relate generally to damage assessment for vehicles. More specifically, various embodiments of the disclosure relate to methods and systems for predicting true age of damages inflicted on vehicles.

### Description of the Related Art

Damages to a vehicle may be caused due to various reasons such as accidents, rash driving, towing incidents, or the like. Some of these damages may be financially covered by an insurance company or a transportation service provider that owns the vehicle. The insurance company or the transportation service provider may inspect such damages to verify whether the damages are legitimate. Generally, the insurance company or the transportation service provider assigns an official person who physically inspects the damages, and approves or disapproves damage claims based on findings of the inspection.

However, such manual approach of damage assessment is neither efficient nor fool proof, and is also prone to human error. For example, different persons may have different findings during the inspection. Besides, the driver may not be truthful regarding nature, intensity, or cause of the damages. For example, a driver of a vehicle may falsely accuse a towing agency of having caused scratches or dents on the vehicle in a towing incident. In certain scenarios, the inspection of damages may not be performed immediately after the damages have been inflicted. In such scenarios, manual inspection relying on the look and feel of the damage, fails to consider various effects of vehicle usage and external factors on the damage. In other words, the conventional solutions of vehicle damage assessment hugely rely on look and feel of vehicle damages. As a result, the conventional solutions of vehicle damage assessment can be easily deceived, which in turn may cause financial loss to insurance companies, transportation service providers, or owners of vehicles.

In light of the foregoing, there exists a need for a technical solution that overcomes the abovementioned problems and provides an efficient and reliable means for vehicle damage assessment.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

Systems and methods for damage assessment of vehicles are provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

FIG. 1A is a block diagram that illustrates a system environment for enhancing driving experience of a vehicle, in accordance with an exemplary embodiment of the disclosure;

FIG. 1B is another block diagram that illustrates another system environment for enhancing driving experience of a vehicle, in accordance with another exemplary embodiment of the disclosure;

FIG. 2 is a block diagram of a vehicle, in accordance with an exemplary embodiment of the disclosure;

FIG. 3A is a block diagram that illustrates an exemplary scenario for training a classifier for enhancing driving experience of a vehicle, in accordance with an exemplary embodiment of the disclosure;

FIG. 3B is a block diagram that illustrates an exemplary scenario for enhancing driving experience of a vehicle, in accordance with an exemplary embodiment of the disclosure;

FIG. 4 is another block diagram that illustrates another exemplary scenario for enhancing driving experience of a vehicle, in accordance with another exemplary embodiment of the disclosure;

FIG. 5 is a block diagram that illustrates a system architecture of a computer system for enhancing driving experience of a vehicle, in accordance with an exemplary embodiment of the disclosure;

FIG. 6 is a flowchart that illustrates a method for enhancing driving experience of a vehicle, in accordance with an exemplary embodiment of the disclosure; and

FIGS. 7A and 7B, collectively, represent a high-level flowchart that illustrates a method for enhancing driving experience of a vehicle, in accordance with an exemplary embodiment of the disclosure. FIG. 1 is a block diagram that illustrates a system environment for implementing a damage assessment method, in accordance with an exemplary embodiment of the disclosure;

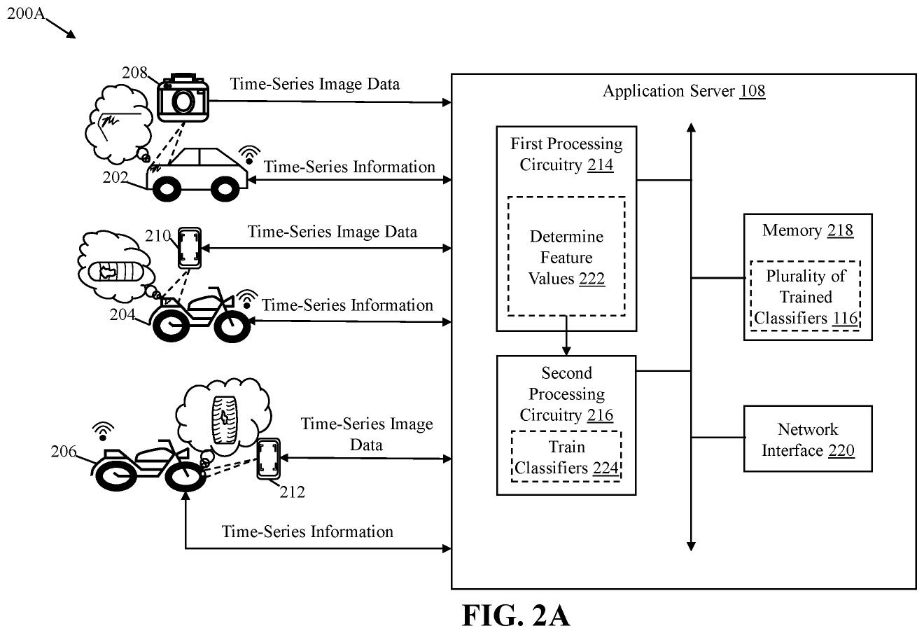

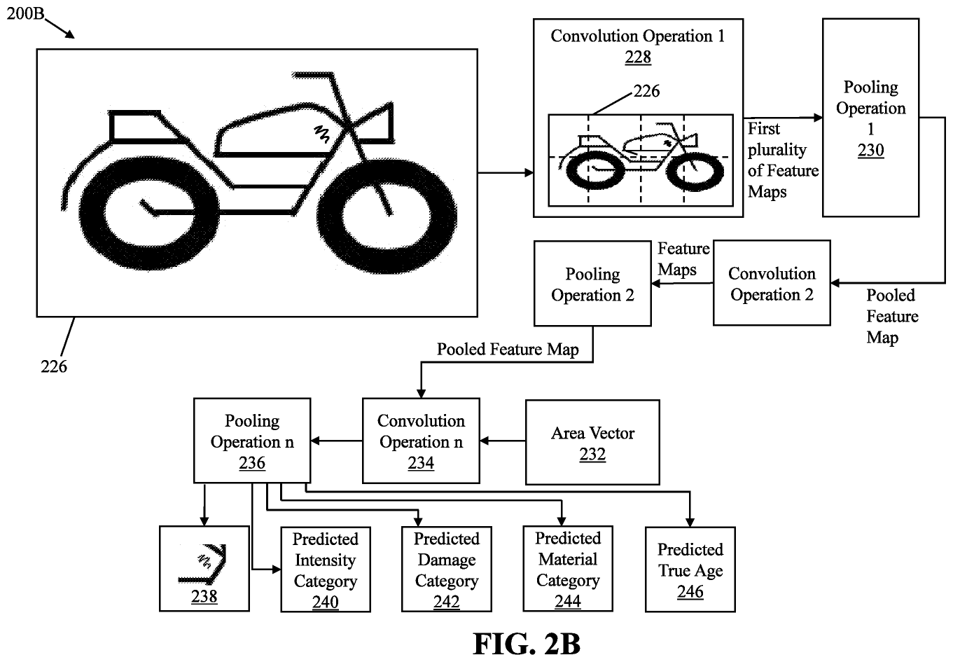

FIGS. 2A and 2B are schematic diagrams that illustrate exemplary scenarios for training a plurality of classifiers, in accordance with an exemplary embodiment of the disclosure;

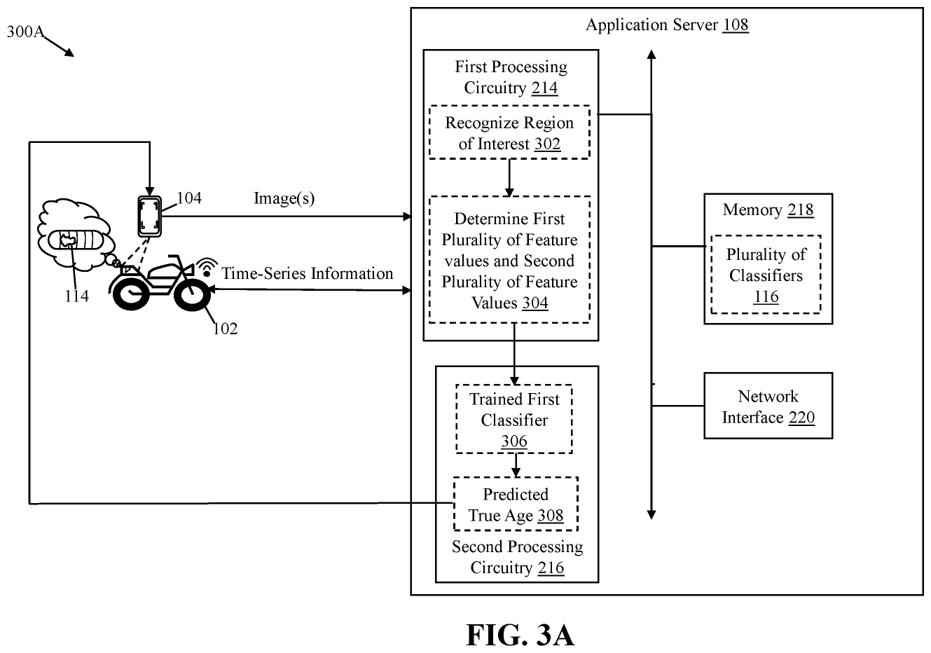

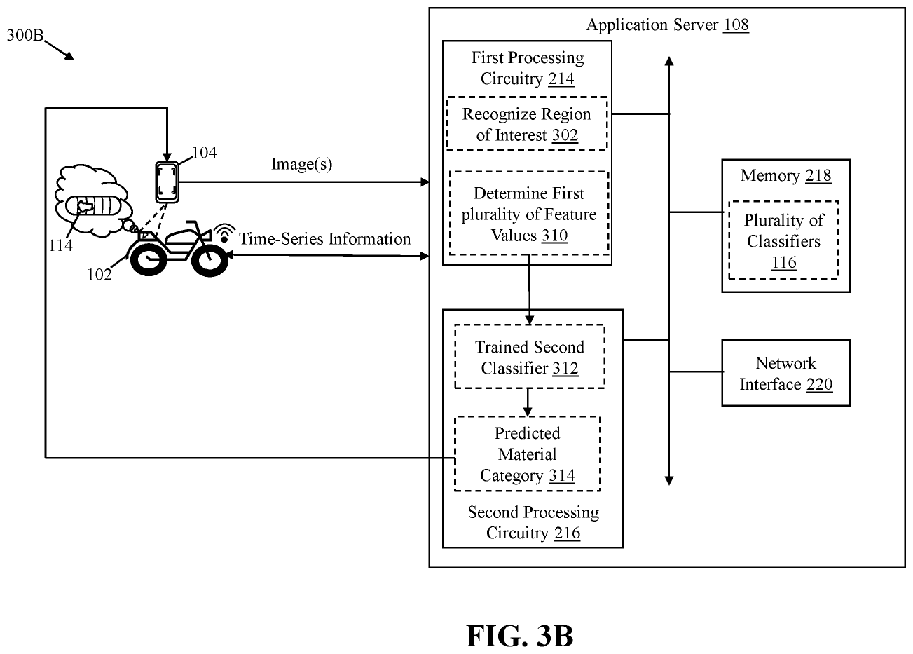

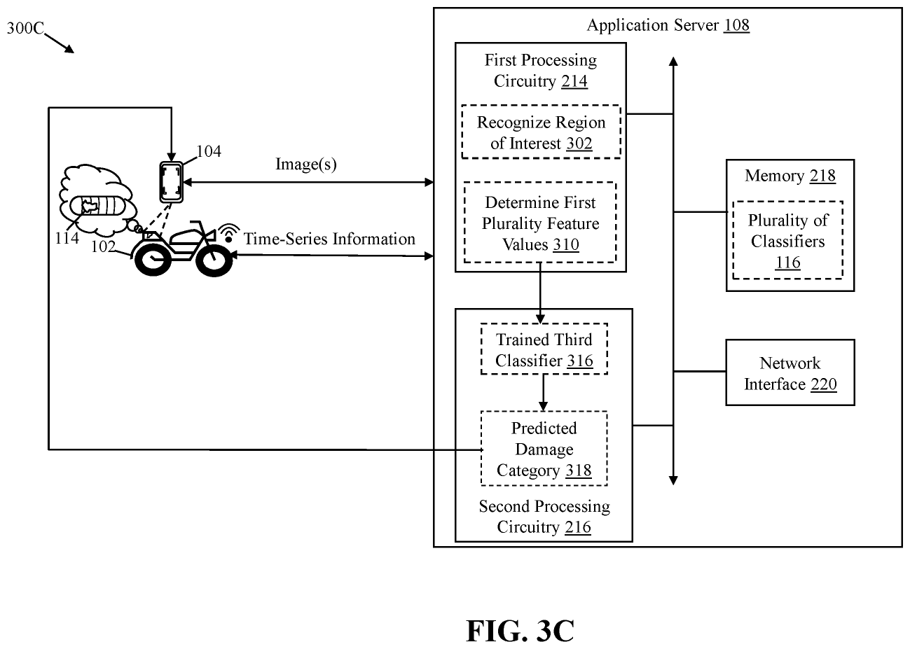

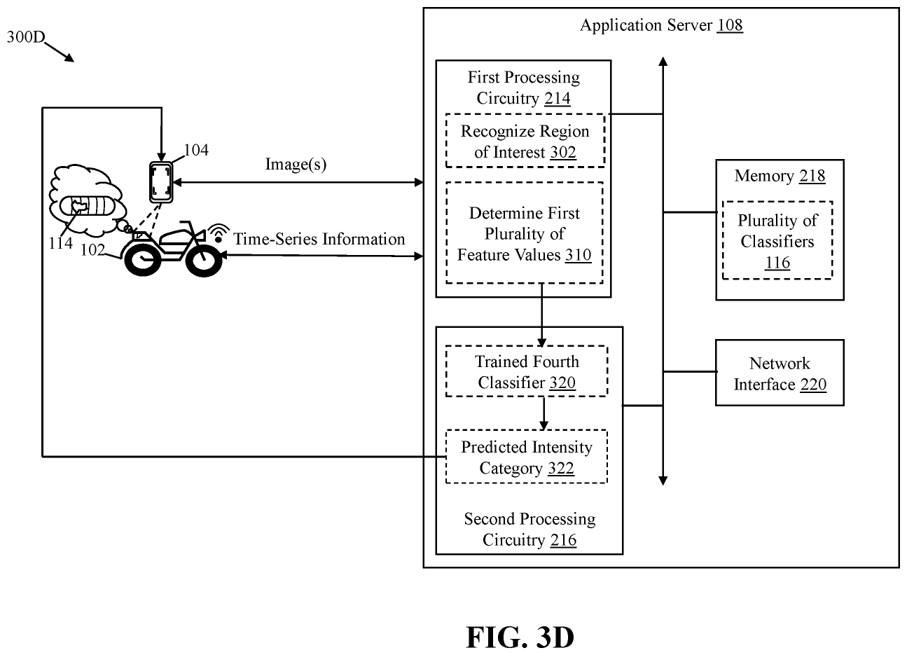

FIG. 3A is a schematic diagram that illustrates an exemplary environment for prediction of true age of a visible damage inflicted on a target vehicle, in accordance with an exemplary embodiment of the disclosure;

FIG. 3B is a schematic diagram that illustrates an exemplary environment for classification of a region of interest into a first material category, in accordance with an exemplary embodiment of the disclosure;

FIG. 3C is a schematic diagram that illustrates an exemplary environment for classification of the region of interest into a first damage category, in accordance with an exemplary embodiment of the disclosure;

FIG. 3D is a schematic diagram that illustrates an exemplary environment for classification of the region of interest into a first intensity category, in accordance with an exemplary embodiment of the disclosure;

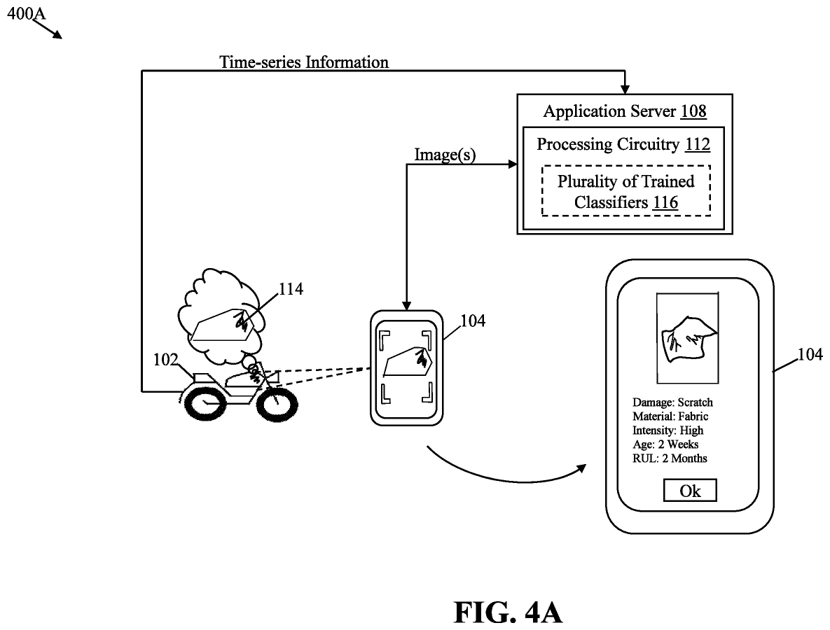

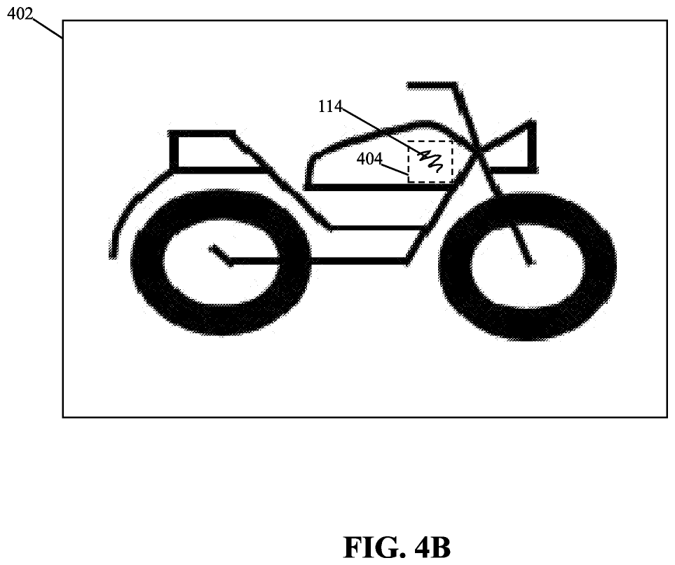

FIGS. 4A and 4B are schematic diagrams that, collectively, illustrate an exemplary scenario for rendering predicted information, in accordance with an exemplary embodiment of the disclosure;

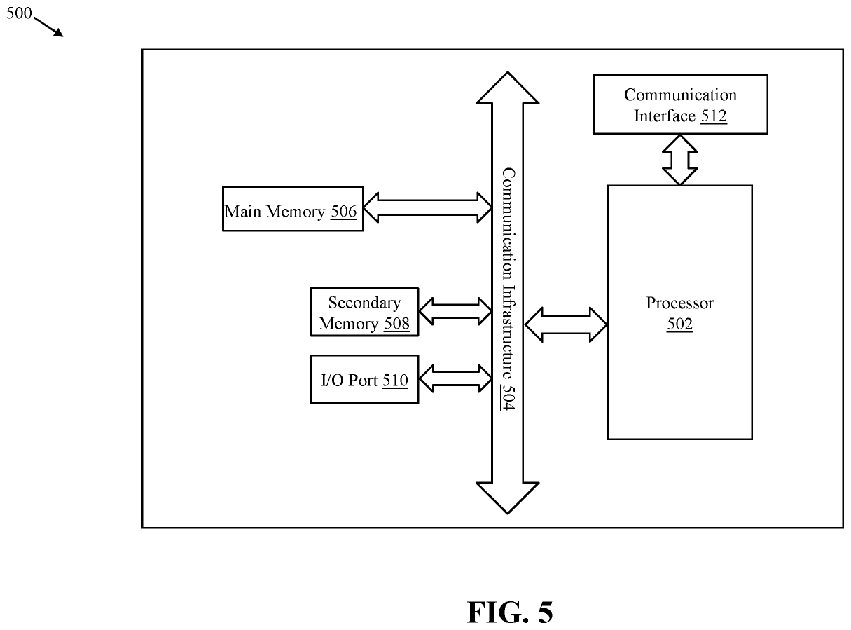

FIG. 5 is a block diagram that illustrates a system architecture of a computer system for implementing the damage assessment method, in accordance with an exemplary embodiment of the disclosure;

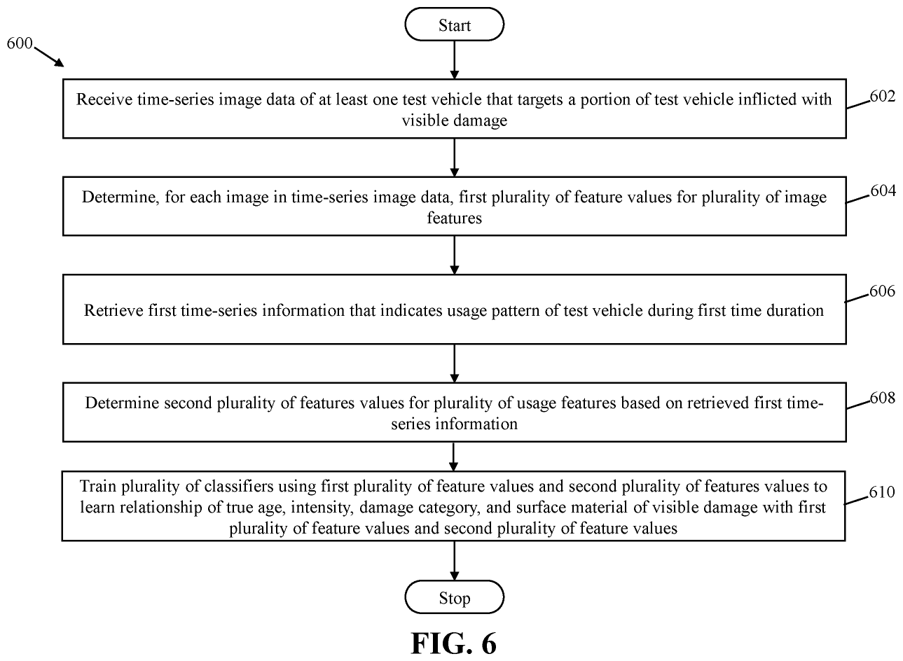

FIG. 6 is a flowchart that illustrates a method for training the plurality of classifiers for damage assessment of vehicles, in accordance with an exemplary embodiment of the disclosure; and

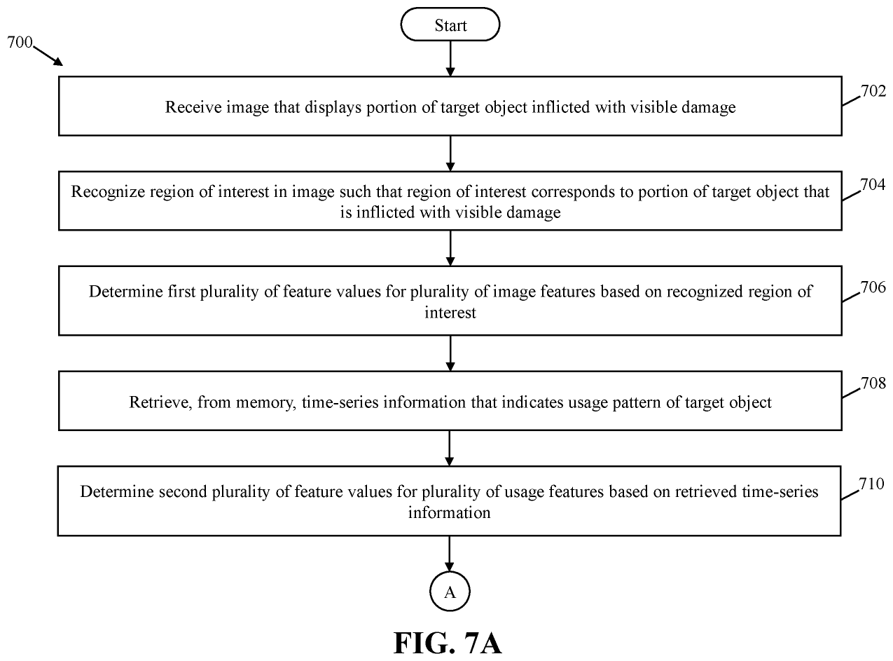

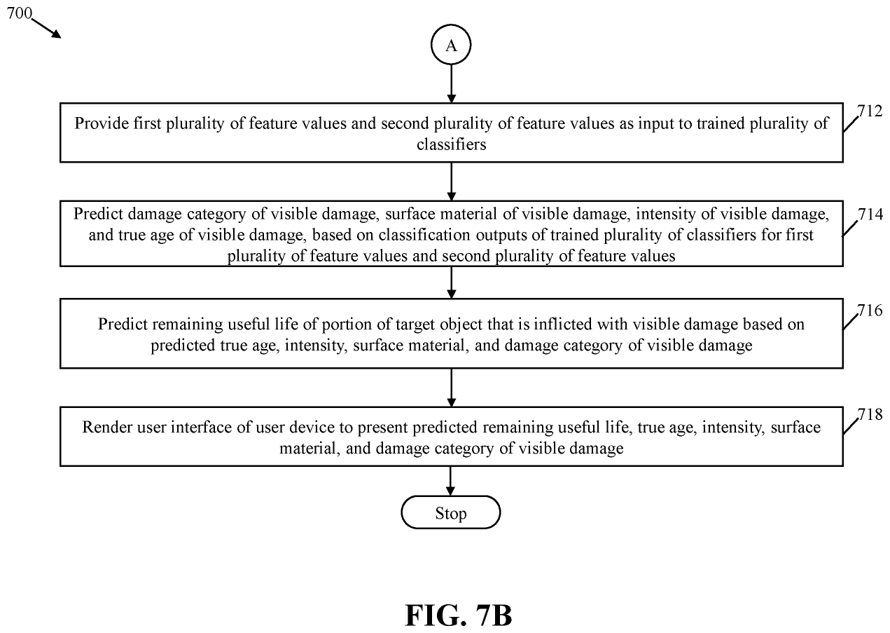

FIGS. 7A and 7B, collectively, represent a flowchart that illustrates the damage assessment method, in accordance with an exemplary embodiment of the disclosure.

### DETAILED DESCRIPTION OF EMBODIMENTS

Certain embodiments of the disclosure may be found in the disclosed systems and methods for assessing damages inflicted on vehicles. Exemplary aspects of the disclosure provide damage assessment methods for vehicles. The methods include various operations that are executed by processing circuitry to predict a true age of a damage inflicted on a vehicle. In an embodiment, the processing circuitry may be configured to recognize a region of interest in an image that has a target object displayed therein. The region of interest corresponds to a portion of the target object in the image that is inflicted with a visible damage. The image is captured by an imaging device at a first-time instance. The processing circuitry may be further configured to determine a first plurality of feature values for a plurality of image features based on the recognized region of interest. The processing circuitry may be further configured to retrieve, from a memory, time-series information that indicates a usage pattern of the target object. The processing circuitry may be further configured to determine a second plurality of feature values for a plurality of usage features based on the retrieved time-series information. The processing circuitry may be further configured to provide the first plurality of feature values and the second plurality of feature values as input to a trained first classifier. The processing circuitry may be further configured to predict a true age of the visible damage based on a first classification output of the trained first classifier for the first plurality of feature values and the second plurality of feature values. The true age indicates a time duration between the first-time instance and a historical time instance at which the target object was inflicted with the visible damage.

In an embodiment, the processing circuitry may be further configured to receive time-series image data of at least one test vehicle. Each image in the time-series image data targets a portion of the test vehicle that is inflicted with a visible damage. The time-series image data is received for a first-time duration that begins from a time instance of infliction of the visible damage on the test vehicle. The processing circuitry may be further configured to determine, for each image in the time-series image data, a first plurality of feature values for a plurality of image features. The processing circuitry may be further configured to retrieve, from a memory, first time-series information that indicates a usage pattern of the test vehicle during the first-time duration. The processing circuitry may be further configured to determine a second plurality of feature values for a plurality of usage features based on the retrieved first time-series information. The second plurality of feature values is determined with respect to each image in the time-series image data. The processing circuitry may be further configured to train a classifier using the first plurality of feature values and the second plurality of feature values to learn a relationship between a true age of the visible damage, the first plurality of feature values, and the second plurality of feature values. The trained classifier may be used to predict a true age of a visible damage inflicted on a target vehicle based on an image that captures the visible damage and second time-series information that indicates a usage pattern of the target vehicle.

In another embodiment, the processing circuitry may be further configured to receive the image of the target object from a memory or over a communication network.

In another embodiment, the processing circuitry may be further configured to provide the first plurality of feature values as input to a trained second classifier. The processing circuitry may be further configured to classify the region of interest into a first material category of a plurality of material categories based on a second classification output of the trained second classifier for the first plurality of feature values. The plurality of material categories may include metal, plastic, and fabric.

In another embodiment, the processing circuitry may be further configured to provide the first plurality of feature values as input to a trained third classifier. The processing circuitry may be further configured to classify the region of interest into a first damage category of a plurality of damage categories based on a third classification output of the trained third classifier for the first plurality of feature values. The plurality of damage categories may include a crack, a scratch, and a dent.

In another embodiment, the processing circuitry may be further configured to provide the first plurality of feature values as input to a trained fourth classifier. The processing circuitry may be further configured to classify the region of interest into a first intensity category of a plurality of intensity categories based on a fourth classification output of the trained fourth classifier for the first plurality of feature values. The plurality of intensity categories may include a high intensity and a low intensity.

In another embodiment, the processing circuitry may be further configured to predict a remaining useful life of the portion of the target object based on the predicted true age of the visible damage and the first intensity category into which the region of interest is classified.

In another embodiment, the plurality of image features may include a count of image pixels associated with the region of interest, a size of the recognized region of interest, a diameter of the visible damage in the recognized region of interest, a contrast between the region of interest and a surrounding surface of the region of interest in the received image, and a texture of the region of interest.

In another embodiment, the plurality of image features may further include a relative distance of the region of interest from another visible damage in a surrounding region of the region of interest and a type of component of the target object associated with the region of interest.

In another embodiment, the usage pattern of the target object may indicate one or more external and environmental conditions to which the target object has been exposed during a use of the target object and one or more object handling attributes of the target object. The time-series information may include time-series values of each of the one or more external and environmental conditions and the one or more object handling attributes.

In another embodiment, the plurality of usage features may include a temperature, humidity, rain, an altitude, and a friction coefficient to which the target object has been exposed.

In another embodiment, the plurality of usage features may include a count of different users that have used the target object, a count of washing incidents associated with the target object, a count of maintenance and repair incidents of the target object, and a frequency of breakdown of the target object.

In an embodiment, the target object may be a vehicle. The plurality of usage features may include a cumulative distance for which the target object has been driven, a cumulative time duration for which the target object has been driven, a parking location of the target object, a count of accidents of the target object, an acceleration profile of the target object, a velocity profile of the target object, a braking profile of the target object, a count of towing incidents associated with the target object, and a timestamp of each towing incident.

In another embodiment, the plurality of usage features may further include a count of historical visible damages inflicted on the target object, a position of each historical visible damage, and a true age of each historical visible damage.

The methods and systems of the disclosure provide a solution for damage assessment of vehicles. The disclosed methods and systems enable prediction of a true age of a visible damage inflicted to a vehicle. The disclosed methods and systems may perform such prediction based on one or more images of the visible damage and usage information associated with the vehicle. Further, such prediction of true age of the visible damage may significantly simplify a process of determination and verification the true age of the visible damage.

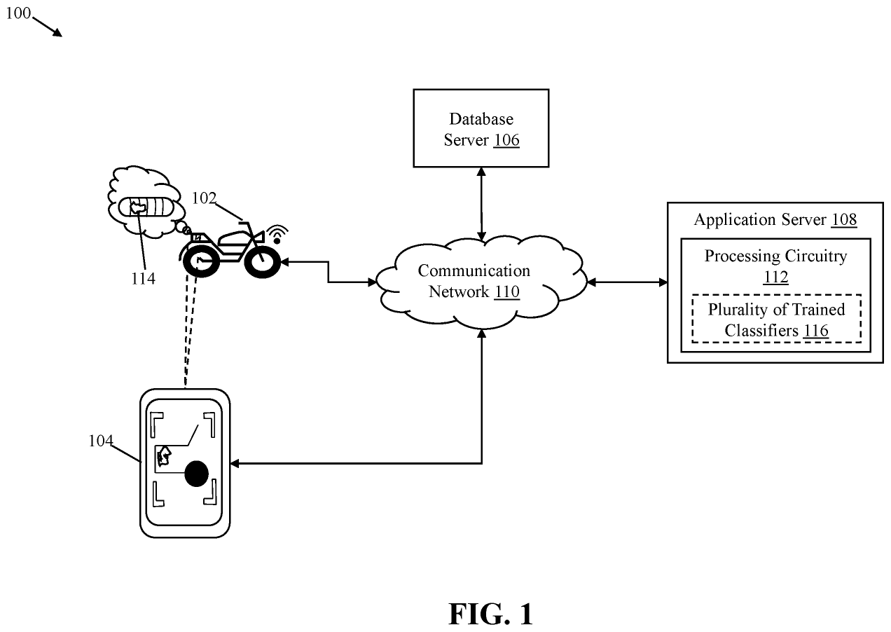

FIG. 1 is a schematic diagram that illustrates a system environment for implementing a damage assessment method, in accordance with an exemplary embodiment of the disclosure. Referring to FIG. 1, a system environment 100 is shown that includes a target vehicle 102, an imaging device 104, a database server 106, an application server 108, and a communication network 110. The application server 108 may include processing circuitry 112. The application server 108 may be configured to communicate with the target vehicle 102, the imaging device 104, and the database server 106 by way of the communication network 110. Examples of the communication network 110 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities (such as the target vehicle 102, the imaging device 104, the database server 106, and the application server 108) in the system environment 100 may be communicatively coupled to the communication network 110 in accordance with various wired and wireless communication protocols, such as Transmission Control Protocol and Internet Protocol (TCP/IP), User Datagram Protocol (UDP), Long Term Evolution (LTE) communication protocols, or any combination thereof. In one example, the target vehicle 102 may be communicatively coupled to the communication network 110 via one of corresponding telematics devices, corresponding driver devices, or a connected car network handled by a third-party server.

The target vehicle 102 may be a mode of transport and may include suitable logic, circuitry, interfaces, and/or code, executable by the circuitry, that may be configured to control and perform one or more operations with or without driving assistance received from corresponding driver. In an embodiment, the target vehicle 102 may be associated with a transportation service provider (e.g., a cab service provider, an on-demand transportation service provider, or the like) to cater to traveling requirements of various passengers. In another embodiment, the target vehicle 102 may be privately owned by the corresponding driver and may be used for fulfilling self-traveling requirements. Examples of the target vehicle 102 may include, but are not limited to, an automobile, a bus, a car, an auto-rickshaw, a scooter, and a bike. For the sake of brevity, the target vehicle 102 is shown to be a two-wheeled vehicle (e.g., a motorbike). In other embodiments, the target vehicle 102 may be a three-wheeled vehicle (e.g., an auto-rickshaw), a four-wheeled vehicle (e.g., a car), or the like. In an embodiment, the target vehicle 102 may have one or more physical damages (e.g., a visible damage 114) inflicted thereon. The visible damage 114 may be inflicted on the target vehicle 102 as wear and tear during regular usage or during an accident, a parking attempt, a towing incident, or the like. Examples of the visible damage 114 may include, but are not limited to, a scratch, a tear, a dent, a breakage, or the like. For the sake of illustration, the visible damage 114 is shown to be inflicted on a seat of the target vehicle 102.

In one exemplary scenario, an owner of the target vehicle 102 may raise a damage claim to cover the expenses associated with a repair of the visible damage 114. In order to determine authenticity and legitimacy of the damage claim, a true age of the visible damage 114 is required to be determined. The true age of the visible damage 114 may refer to a time-period between a first time-instance (e.g., a current time instance) and a historical time instance at which the visible damage 114 was inflicted on the target vehicle 102. In addition, the true age of the visible damage 114 may be different from a perceived age of the visible damage 114. The perceived age may solely rely on look and feel of the visible damage 114. For example, the visible damage 114 may appear to be to 2-3 months old (e.g., perceived age); however, the true age of the visible damage 114 may only be two weeks. In another example, the visible damage 114 may appear to be to one week old; however, the true age of the visible damage 114 may be one month. The true age and the perceived age of the visible damage 114 may differ on account of usage of the target vehicle 102 and various environmental conditions that the target vehicle 102 is exposed to. Thus, relying on the look and feel of the visible damage 114 to infer an age of the visible damage 114 may be erroneous.

For determining the true age of the visible damage 114, an image of the visible damage 114 is captured via the imaging device 104 at the first time-instance. The imaging device 104 may refer to a digital device capable of capturing one or more images (e.g., digital images) of a field of view. Examples of the imaging device 104 may include, a smartphone with a camera, a camera, a wearable computing device, a laptop, image sensors, a multi-camera device, or the like. In an embodiment, the imaging device 104 may be used by the driver of the target vehicle 102 or any other individual to capture the image of a portion of the target vehicle 102 that includes the visible damage 114. In another embodiment, the imaging device 104 may be configured to automatically focus on the visible damage 114 without any external interference. In some embodiments, the imaging device 104 may be installed in an inspection facility where vehicles are inspected for visible damage claims.

The database server 106 may include suitable logic, circuitry, interfaces, and/or code, executable by the circuitry, that may be configured to perform one or more operations for collecting and storing one or more images of the visible damage 114 and/or time-series information associated with a usage pattern of the target vehicle 102. The database server 106 may collect the one or more images of the visible damage 114 and the time-series information associated with the usage pattern of the target vehicle 102 from the target vehicle 102, the imaging device 104, and/or corresponding driver devices (for example, a mobile phone of corresponding driver). Examples of the database server 106 may include a cloud-based database, a local database, a distributed database, a database management system (DBMS), or the like. The database server 106 may communicate the one or more images and the time-series information to the application server 108 in a periodic manner, when prompted by the driver or the application server 108, or when the target vehicle 102 is inflicted with any damage (for example, the visible damage 114).

The application server 108 may include suitable logic, circuitry, interfaces, and/or code, executable by the circuitry, that may be configured to perform one or more operations for damage assessment of the target vehicle 102. Examples of the application server 108 may include a cloud-based server, a local server, a group of centralized servers, a group of distributed servers, or the like. The application server 108 may be configured to operate in two modes such as a training mode and an implementation mode. The application server 108 may operate in the training mode for training a plurality of classifiers 116 (e.g., a first classifier, a second classifier, a third classifier, and a fourth classifier) for damage assessment of vehicles. After the plurality of classifiers 116 are trained, the application server 108 may operate in the implementation mode. Operations of the application server 108 in the training mode and the implementation mode are executed by the processing circuitry 112.

The processing circuitry 112 may include suitable logic, circuitry, interfaces, and/or code, executable by the circuitry, that may be configured to perform one or more operations in the training mode and the implementation mode. The processing circuitry 112 may be configured to perform operations associated with data collection and data processing. The processing circuitry 112 may be implemented by one or more processors, such as, but not limited to, an application-specific integrated circuit (ASIC) processor, a reduced instruction set computing (RISC) processor, a complex instruction set computing (CISC) processor, and a field-programmable gate array (FPGA) processor. The one or more processors may also correspond to central processing units (CPUs), graphics processing units (GPUs), network processing units (NPUs), digital signal processors (DSPs), or the like. It will be apparent to a person of ordinary skill in the art that the processing circuitry 112 may be compatible with multiple operating systems.

In operation, during the training mode, the processing circuitry 112 may be configured to receive historical data corresponding to a training time-interval (e.g., a first-time duration) for a plurality of test vehicles (shown in FIG. 2). The plurality of test vehicles may or may not include the target vehicle 102. Examples of the training time-interval may include one day, two days, one week, two weeks, one month, six months, or the like. In some embodiments, the processing circuitry 112 may receive the historical data from the database server 106. In some embodiments, the processing circuitry 112 may receive the historical data from a vehicle control device of each test vehicle of the plurality of test vehicles. The historical data may include time-series image data associated with one or more visible damages inflicted on each test vehicle of the plurality of test vehicles as well as first time-series information associated with each test vehicle of the plurality of test vehicles. The time-series image data may include a plurality of images of one or more visible damages inflicted on each test vehicle of the plurality of test vehicles in a chronological order. In other words, the time-series image data may include a time-series of images of one or more visible damages inflicted on each test vehicle of the plurality of test vehicles. The first time-series information may be indicative of a usage pattern of each test vehicle of the plurality of test vehicles in a chronological order. The usage pattern may be indicative of conditions (for example, smoke, fumes, dust, or the like) and environmental conditions (for example, rainfall, temperature, humidity, or the like) to which each test vehicle of the plurality of test vehicles has been exposed to. The usage pattern may be further indicative of object handling attributes of each test vehicle of the plurality of test vehicles. The object handling attributes may include one or more parameters associated with handling of each test vehicle of the plurality of test vehicles.

The processing circuitry 112 may be configured to determine a first plurality of features values corresponding to a first plurality of image features based on the time-series image data of the one or more visible damages inflicted on each test vehicle of the plurality of test vehicles. The processing circuitry 112 may be configured to determine the first plurality of feature values by applying one or more deep learning techniques (e.g., U-Net, Resnet-50, Region-based Convolutional Neural Network (R-CNN), or the like) on the time-series image data. The processing circuitry 112 may be further configured to determine a second plurality of feature values corresponding to a plurality of usage features based on the first time-series information associated with each test vehicle of the plurality of test vehicles. The processing circuitry 112 may be further configured to correlate the first plurality of feature values corresponding to the plurality of image features with a known true age of corresponding visible damage. The processing circuitry 112 may be further configured to correlate the second plurality of feature values corresponding to the plurality of usage features with the known true age of corresponding visible damage. The processing circuitry 112 may be further configured to determine a correlation between the first plurality of feature values of the plurality of image features and the second plurality of feature values of the plurality of usage features.

The plurality of image features may include a count of image pixels associated with a region of interest in an image of a visible damage, a size of the region of interest, a diameter of the visible damage in the region of interest, a contrast between the region of interest and a surrounding surface of the region of interest in the image, and a texture of the region of interest. A region of interest may refer to a portion of an image that depicts (e.g., represents) a visible damage caused to a vehicle. The plurality of image features may further include a relative distance of the region of interest from another visible damage in a surrounding region of the region of interest and a type of component of each vehicle of the plurality of test vehicles associated with the region of interest.

The plurality of usage features may include a temperature in which a vehicle has been driven, a humidity level in which the vehicle has been driven, a rainfall to which the vehicle has been exposed, an altitude at which the vehicle has been driven, and a friction coefficient to which the vehicle has been exposed. The plurality of usage features may further include a count of different users that have used the vehicle, a count of washing incidents associated with the vehicle, a count of maintenance and repair incidents of the vehicle, and a frequency of breakdown of the vehicle. The plurality of usage features may further include a cumulative distance for which the vehicle has been driven, a cumulative time duration for which the vehicle has been driven, a parking location of the vehicle, a count of accidents of the vehicle, an acceleration profile of the vehicle, a velocity profile of the vehicle, a braking profile of the vehicle, a count of towing incidents associated with the vehicle, and a timestamp of each towing incident. The plurality of usage features may further include a count of historical visible damages inflicted on the vehicle, a position of each historical visible damage, and a true age of each historical visible damage.

The processing circuitry 112 may be further configured to determine a weight corresponding to each of the plurality of image features and the plurality of usage features. The weight of each feature of the plurality of image features and the plurality of usage features may be determined based on a significance of each feature of the plurality of image features and the plurality of usage features in influencing the visible damage inflicted on the vehicle. A first usage feature that directly affects the visible damage inflicted on the vehicle may be weighted higher than a second usage feature that indirectly affects the visible damage inflicted on the vehicle. For example, a usage feature “a count of rash driving incidents” may directly affect the visible damage, and hence may be weighted higher than another usage feature “a count of users/drivers associated with a vehicle” that indirectly affects the visible damage.

The processing circuitry 112 may be further configured to train the plurality of classifiers 116 based on the first plurality of feature values for the plurality of image features, the second plurality of feature values for the plurality of usage features, and one or more correlations therebetween. Various details associated with the training of the plurality of classifiers 116 are described in conjunction with FIG. 2. Upon training of the plurality of classifiers 116, the processing circuitry 112 may be configured to operate in the implementation mode.

During the implementation mode, the processing circuitry 112 may be configured to receive at least one image of the visible damage 114 inflicted on the target vehicle 102. The image may be captured by the imaging device 104 at the first time-instance (e.g., the current time-instance). The processing circuitry 112 may receive the image from one of the database server 106 and the imaging device 104, via the communication network 110. Throughout the description the term “target vehicle 102” is interchangeably referred to as “target object 102”. For sake of brevity, the target object 102 is shown to be a vehicle. In other embodiments, the target object 102 may be another object different from a vehicle, such as, but not limited to, a television, a locker, an antique, or the like.

The processing circuitry 112 may be configured to recognize a region of interest in the received image. The region of interest in the image may correspond to a region of the image that presents a portion of the target object (e.g., the target vehicle 102) that has the visible damage 114 inflicted thereon. The image may be captured by the imaging device 104 at the first-time instance (e.g., the current time instance). The first-time instance may refer to any time instance after the infliction of the visible damage 114 on the target vehicle 102.

The processing circuitry 112 may be further configured to determine a third plurality of feature values for the plurality of image features based on the recognized region of interest. The processing circuitry 112 may be configured to determine the third plurality of feature values by applying one or more deep learning techniques (e.g., U-Net, Resnet-50, Region-based Convolutional Neural Network (R-CNN), or the like) on the received image. The processing circuitry 112 may be further configured to retrieve second time-series information that indicates a usage pattern of the target vehicle 102. The application server 108 may retrieve the second time-series information from one of the database server 106, a local memory of the target vehicle 102, or the driver device of the driver of the target vehicle 102. The usage pattern may be indicative of external conditions (for example, smoke, fumes, dust, or the like) and environment conditions (for example, rain, temperature, humidity, or the like) to which the target vehicle 102 has been exposed to during the use of the target vehicle 102. The usage pattern may be further indicative of object handling attributes of the target vehicle 102. The object handling attributes may include one or more parameters associated with the handling of the target vehicle 102.

Examples of the object handling attributes may include, but are not limited to, a pattern of locking the target vehicle 102, a charging or refuelling pattern, and accessory usage pattern of one or more accessories of the target vehicle 102. The processing circuitry 112 may be further configured to determine a fourth plurality of feature values for the plurality of usage features based on the retrieved second time-series information. The processing circuitry 112 may be further configured to provide the third plurality of feature values and the fourth plurality of feature values as input to a trained first classifier of the plurality of classifiers 116. The trained first classifier may generate a first classification output based on the third plurality of feature values and the fourth plurality of feature values. Subsequently, the processing circuitry 112 may be further configured to predict a true age of the visible damage 114 based on the first classification output of the trained first classifier. The true age may indicate a time duration between the first time-instance (i.e., when the image was captured) and the historical time-instance at which the target vehicle 102 was inflicted with the visible damage 114. In other words, the trained first classifier is capable of predicting the true age of the visible damage 114 based on the third plurality of feature values and the fourth plurality of feature values, in spite of the historical time-instance at which the target vehicle 102 was inflicted with the visible damage 114 being unknown.

The processing circuitry 112 may be further configured to provide the third plurality of feature values as an input to the trained second classifier of the plurality of classifiers 116. The trained second classifier may generate a second classification output based on the inputted third plurality of feature values. The processing circuitry 112 may be further configured to classify the region of interest into a first material category of a plurality of material categories based on the second classification output of the trained second classifier for the third plurality of feature values. The plurality of material category may refer to possible material types with which various portions of a vehicle are made of. The plurality of material categories may include metal, plastic, and fabric. The first material category into which the region of interest is classified may refer to a material type of the portion of the target vehicle 102 that is inflicted with the visible damage 114.

The processing circuitry 112 may be further configured to provide the third plurality of feature values as an input to the trained third classifier of the plurality of classifiers 116. The trained third classifier may generate a third classification output based on the inputted third plurality of feature values. The processing circuitry 112 may be further configured to classify the region of interest into a first damage category of a plurality of damage categories based on the third classification output of the trained third classifier. The plurality of damage categories may refer to various types of damage that may be inflicted on a vehicle. For example, the plurality of damage categories may include a crack, a scratch, a bent, a tear, a ding, a dent, of the like. The first damage category into which the region of interest is classified may be indicative of a type of the visible damage 114 inflicted on the target vehicle 102.

The processing circuitry 112 may be further configured to provide the third plurality of feature values as an input to the trained fourth classifier of the plurality of classifiers 116. The trained fourth classifier may generate a fourth classification output based on the inputted third plurality of feature values. The processing circuitry 112 may be further configured to classify the region of interest into a first intensity category of a plurality of intensity categories based on the fourth classification output of the trained fourth classifier for the third plurality of feature values. The plurality of intensity categories may refer to severity levels of a visible damage. For example, the plurality of intensity categories may include a high intensity, a medium intensity, and a low intensity. In some embodiments, the intensity of a visible damage may refer to a level of impact of the visible damage on one of a monetary value of a vehicle, a health of one or more components of the vehicle, and one or more operations of the vehicle. In some embodiments, the intensity of a visible damage may refer to a depth or a size of the visible damage.

The processing circuitry 112 may be further configured to predict a remaining useful life (RUL) of the portion of the target vehicle 102 that is inflicted with the visible damage 114 based on the predicted true age of the visible damage 114 and the first intensity category into which the region of interest is classified. The RUL of the target vehicle 102 may refer to an estimated time for which the portion of the target vehicle 102 may remain operable, after which the portion of the target vehicle 102 may either require a repair or a replacement.

FIGS. 2A and 2B are schematic diagrams that illustrate exemplary scenarios for training the plurality of classifiers, in accordance with an exemplary embodiment of the disclosure. FIG. 2A is described in conjunction with elements of FIG. 1. Referring to FIG. 2A, an exemplary environment 200A is shown that includes the plurality of test vehicles (hereinafter, the term “plurality of test vehicles” is referred to as “plurality of test vehicles 202-206”) and the application server 108. It will be apparent to a person skilled in the art that the plurality of test vehicles 202-206 may or may not include the target vehicle 102. Each test vehicle of the plurality of test vehicles 202-206 may be associated with corresponding imaging device 208-212. The application server 108 may include first processing circuitry 214, second processing circuitry 216, a memory 218, and a network interface 220. The first processing circuitry 214 and the second processing circuitry 216 may collectively refer to the processing circuitry 112 of FIG. 1.

The first processing circuitry 214 may include suitable logic, circuitry, interfaces, and/or code, executable by the circuitry, that may be configured to execute the instructions stored in the memory 218 to perform various operations associated with data collection and data processing. The first processing circuitry 214 may be further configured to perform various operations for analyzing and processing time-series information (e.g., the first time-series information) received from the plurality of test vehicles 202-206 and time-series image data received from the imaging devices 208-212 corresponding to the plurality of test vehicles 202-206 to determine the first plurality of feature values and the second plurality of feature values. The first processing circuitry 214 may be implemented by one or more processors, such as, but not limited to, an ASIC processor, a RISC processor, a CISC processor, and an FPGA processor. The one or more processors may also correspond to CPUs, GPUs, NPUs, or the like. It will be apparent to a person of ordinary skill in the art that the first processing circuitry 214 may be compatible with multiple operating systems.

During the training mode, the first processing circuitry 214 may be configured to receive the historical data associated with the plurality of test vehicles 202-206. The historical data may include the first time-series information and the time-series image data associated with the plurality of test vehicles 202-206 for the training time-interval such as the first-time duration. Examples of first-time duration may include one week, two weeks, three weeks, and so on. The time-series image data of each test vehicle of the plurality of test vehicles 202-206 may include a plurality of images in a chronological order, of the visible damage caused to each test vehicle. The chronological order may range from a time-instance when the visible damage was inflicted on each test vehicle of the plurality of test vehicles 202-206 to a time-instance during the training time-interval when a last image of the visible damage has been captured. For example, if the training time-interval for the test vehicle 202 is 14 days starting from a time-instance when the damage was inflicted on the test vehicle 202, the chronological order may start from the time-instance when the damage was inflicted on the test vehicle 202 and may end at a time-instance on the 14th day when a last image of the visible damage was captured. The first time-series information of each test vehicle of the plurality of test vehicles 202-206 may be indicative of the usage pattern of each test vehicle of the plurality of test vehicles 202-206 during the training time-interval. The usage pattern of each test vehicle of the plurality of test vehicles 202-206 may indicate one or more external and environmental conditions to which each test vehicle of the plurality of test vehicles 202-206 has been exposed to due to the use of each test vehicle of the plurality of test vehicles 202-206 and one or more object handling attributes of each test vehicle of the plurality of test vehicles 202-206. The first time-series information may include time-series values of each of the one or more external and environmental conditions and the one or more object handling attributes. The one or more external conditions may include a state of roads on which each test vehicle of the plurality of test vehicles 202-206 has been driven, a state of traffic in which each test vehicle of the plurality of test vehicles 202-206 has been driven, or the like. The environmental conditions may include a temperature, a rainfall, a humidity, or the like to which each test vehicle of the plurality of test vehicles 202-206 has been exposed to. In an example, time-series values of environmental conditions may include “exposure to 50 degrees Celsius on Day 1”, “exposure to 55 degrees Celsius on Day 2”, and so on.

In some embodiments, each image in the time-series image data may be associated with multiple labels. For example, a first mage in the time-series image data indicating a visible damage on the test vehicle 202 may be associated with first through fourth labels. The first label may indicate a true age of the visible damage inflicted on the test vehicle 202 and the second label may indicate a material type of a portion of the test vehicle 202 that is inflicted with the visible damage. The third label may indicate a type (for example, a crack, a dent, a scratch, a tear, or the like) of the visible damage and the fourth label may indicate an intensity (e.g., high intensity, medium intensity, or low intensity) of the visible damage.

The first processing circuitry 214 may be configured to analyze the time-series image data to determine the first plurality of feature values corresponding to the plurality of image features for each image in the time-series image data and the first time-series information to determine the second plurality of feature values corresponding to the plurality of usage features (represented by dotted box 222). The second plurality of feature values may be determined with respect to each image in the time-series image data. For example, the time-series image data of the test vehicle 202 may include 14 images captured by the imaging device 208. The imaging device 208 may have captured, for example, one image per day after the infliction of a visible damage on the test vehicle 202. The first time-series information of the test vehicle 202 may include time-series values of the one or more external and environmental conditions and the one or more object handling attributes that the test vehicle 202 was exposed to for 14 days after the infliction of the visible damage on the test vehicle 202. In other words, the first time-series information of the test vehicle 202 may include day level data of the one or more external and environmental conditions and the one or more object handling attributes. In such a scenario, the first processing circuitry 214 may determine the first plurality of feature values corresponding to the plurality of image features for each of the 14 images. Similarly, the second plurality of feature values corresponding to the plurality of usage features may be determined with respect each of the 14 images. Here, the first processing circuitry 214 may determine the second plurality of feature values at day level as the 14 images were captured at day level. Thus, the first processing circuitry 214 may use the one or more external and environmental conditions and the one or more object handling attributes that the test vehicle 202 was exposed to on a first day to determine the second plurality of feature values with respect to the image captured on the first day. The first processing circuitry 214 may use the one or more external and environmental conditions and the one or more object handling attributes that the test vehicle 202 was exposed to on a second day to determine the second plurality of feature values with respect to the image captured on the second day. Determining the first plurality of feature values and the second plurality of feature values in a chronological order allows the first processing circuitry 214 to capture a correlation of between the true age of the visible damage with the plurality of image features and the plurality of usage features.

It will be apparent to a person of ordinary skill in the art that a frequency of capturing images for the time-series image data may be varied depending upon a desired prediction accuracy level and an availability of computational resources. For example, an increase in the frequency of capturing images for the time-series image data may result in an increase in the number of images to be analyzed by the first processing circuitry 214, which in turn may increase the prediction accuracy level and require more computational resources. However, a decrease in the frequency of capturing images for the time-series image data may result in a decrease in the number of images to be analyzed by the first processing circuitry 214, which in turn may decrease the prediction accuracy level and may require less computational resources. Thus, an optimal frequency of capturing images may be set by the first processing circuitry 214 as a trade-off between the prediction accuracy level and the available computational resources.

The plurality of image features may include a count of image pixels associated with a region of interest, a change in a magnitude (e.g., intensity and/or luminance) of the image pixels associated with the region of interest, a size of the recognized region of interest, a diameter of the visible damage in the recognized region of interest, a contrast between the region of interest and a surrounding surface of the region of interest in the received image, and a texture of the region of interest. Here, a region of interest in an image may display a portion of a vehicle that is inflicted with a visible damage.

A digital image may include a plurality of image pixels arranged in rows and columns. The count of image pixels associated with the region of interest may refer to a number of image pixels that form the region of interest and presents the visible damage. An increase in the count of image pixels associated with the region of interest over time may be indicative of an increase in dimensions of the visible damage. The change in magnitude of image pixels associated with the region of interest may be indicative of an increase in severity (for example, an increase in rusting of a crack on a metal part) of the visible damage. The size of the region of interest may refer to physical dimensions such as length and breadth of the region of interest. The size of the region of interest is considered with an assumption that images in the time-series image data have been captured with constant camera, light, and distance configurations. An increase in the size of the region of interest may be indicative of an increase in size of the visible damage.

The diameter of the visible damage in the region of interest may indicate whether the visible damage is small, large, or is increasing in size with time. In an example, a diameter of the visible damage in the region of interest may be 2 centimeters in a first image of the time-series image data of the test vehicle 202 and the diameter of the visible damage in the region of interest may be 2.5 centimeters in a second image of the time-series image data of the test vehicle 202. Here, the second image may be captured after the first image. Therefore, an increase of 0.5 centimeters in the diameter of the visible damage may be indicative of an increase in the dimensions of the visible damage inflicted on the test vehicle 202.

The contrast between the region of interest and the surrounding surface of the region of interest in the received image may be indicative of a difference in color intensity or luminance between the region of interest in an image and remaining portion of the image that surrounds the region of interest. In an example, the test vehicle 202 may be red in color and may have a scratch on its outer body. The scratch may be of “silver” color and hence may have a higher luminance than surrounding red color of rest of the outer body of the test vehicle 202. Therefore, the contrast between the region of interest may be indicative of severity, size, or the like of the visible damage. In addition, the contrast between the region of interest and the surrounding surface of the region of interest in the received image may be indicative of a level of rusting (in case of metal) in the region of interest. In addition, the contrast between the region of interest and the surrounding surface of the region of interest in the received image may be indicative a presence of debris, a dirt build-up, and sharpness of various edges in the region of interest.

The texture of the region of interest may be indicative of a stage of damage of the visible damage. In an example, a fabric of a seat of the test vehicle 202 may have worn out due to environmental effects such as humidity, temperature, or the like. Therefore, a texture of the worn-out fabric may be rough and grainy in a first image of the time-series image data of the test vehicle 202. The texture of the worn-out fabric may be very rough and threads of the fabric could be visible in a second image of the time-series image data of the test vehicle 202. The second image may have been captured after the first image. Therefore, such change in the texture of the region of interest may be indicative of increased severity of the visible damage.

The plurality of image features may further include a relative distance of the region of interest from another visible damage in a surrounding region of the region of interest and a type of vehicle component associated with the region of interest.

The relative distance of the region of interest from another visible damage in the surrounding region of the region of interest may be indicative of how close or far the visible damage is from another visible damage. In an exemplary scenario, a relative distance between a first visible damage on the test vehicle 202 and a second visible damage in the surrounding region of the first visible damage may be less than a first threshold value (e.g., 10 centimeters). In such a scenario, the first and second visible damages may be related to each other, for example, may have been caused at the same time. Hence, the severity of the first visible damage may affect the second visible damage and vice versa. In another, example, the first and second visible damages may be inflicted on two different portions (for example, seat and headlight) of the test vehicle 202, and hence, may be unrelated and may have different true ages.

The type of vehicle component associated with the region of interest may refer to essential or non-essential nature of the vehicle component that is inflicted with the visible damage. For example, an essential vehicle component may indicate that the component may be crucial for operations of a corresponding vehicle and hence is used every time when the vehicle is used. In another example, the non-essential component may indicate that the component may not be crucial for operations of the corresponding vehicle and hence may not be used every time when the vehicle is used. For example, a first visible damage (e.g. a tear) may have been inflicted on a seat of the test vehicle 202 and a second visible damage (e.g., a scratch) may have been inflicted inside a boot space of the test vehicle 202. Further, the type of component may also be indicative of whether the component may get damaged during an accident or the visible damage might have been inflicted before or after the accident. In an example, a fabric of a seat of a first vehicle is unlikely to get torn in a minor accident. Hence, the type of component i.e., the seat may be indicative of the tear in the fabric of seat being older or new than the minor accident of the first vehicle.

The plurality of usage features may include the temperature, humidity, rainfall, altitude, and the friction coefficient to which a vehicle (e.g., the plurality of test vehicles 202-206) has been exposed to. The temperature, humidity, and rainfall in a geographical area in which a vehicle (e.g., any of the plurality of test vehicles 202-206) has been driven may have direct impact on the visible damage inflicted on the vehicle. For example, extreme temperature (very low temperature or very high temperature), high humidity, and heavy rainfall in the geographical area may lead to rapid wear and tear of the visible damage. The altitude at which the vehicle has been driven may impact the visible damage inflicted on the vehicle. The altitude may be indicative of a slope of a road on which the vehicle has been driven. In an example, a vehicle may be driven at a steep road that may lead to extra force being exerted to its wheels. Such extra force being exerted on the wheels may lead to frequent damages caused to tires of the vehicle and such damage may also intensify rapidly due to the rapid force being exerted on the wheels. Further, the friction coefficient to which the vehicle has been exposed may have a direct impact on visible damages caused to a vehicle. A high friction coefficient may lead to high friction or force faced by the vehicle in opposite direction. Such high friction may cause wear and tear of components (e.g., tires, breaks, or the like) of the vehicle as well as may increase severity of an existing visible damage.

The plurality of usage features may further include a count of different users that have used a vehicle, a count of washing incidents associated with the vehicle, the count of maintenance and repair incidents of the vehicle, and the frequency of breakdown of the vehicle.

The count of different users that have used the vehicle may refer to a count of drivers or passengers that may have used the vehicle. The count of different users may be indicative of change of drivers of the vehicle. A frequent change of drivers of the vehicle may expose the vehicle to different driving styles that may have a direct impact on the visible damage inflicted on the vehicle. For example, the test vehicle 202 may have two different users (e.g., a first user and a second user). The first user may be a very attentive and careful driver and may have a good track record of driving the test vehicle 202. The second user may be careless and may have sub-par driving skills. Therefore, the first user may take extra precaution towards the visible damage inflicted on the test vehicle 202 however, the second user may be indifferent towards the visible damage. Hence, a sub-par driving style of the second user may negatively impact the visible damage and may even cause the visible damage to become more severe.

The count of washing incidents associated with a vehicle may refer to number of times the vehicle has been washed. Washing of the vehicle may have direct impact on the visible damage caused to the vehicle. Frequent washing of the vehicle may expose the visible damage to adverse conditions (such as, moisture, external force, or the like) and may lead to an increase in wear and tear, rusting, or the like of the visible damage. Hence, the count of washing incidents may intensify the severity of the visible damage inflicted on the vehicle.

The count of maintenance and repair incidents of a vehicle may refer to a number of maintenances and repairs that have been scheduled for the vehicle to maintain an optimal health thereof. The maintenance and repairs may have been scheduled as a result of one or more visible damages caused to the vehicle. Further, the count of maintenance and repairs may also be indicative of a frequency of visible damages caused to the vehicle. The count of scheduled maintenance sessions of the vehicle may be determined based on a service log corresponding to each vehicle of the plurality of test vehicles 202-206. In an example, the test vehicle 202 may not have any maintenance and repair incident in a year. Such lack of maintenance and repair may cause the visible damage inflicted on the test vehicle 202 to become more severe.

The frequency of breakdown of a vehicle may be indicative of how often breakdowns are suffered by the vehicle. The breakdowns may have caused visible damages or may have increased intensity of existing visible damages caused to the vehicle. In an example, the test vehicle 202 may have suffered a first visible damage during a first breakdown. Further, the test vehicle 202 may have suffered a second breakdown that may have caused a second visible damage in vicinity of the first visible damage. Hence, the second breakdown may not only cause new visible damages but may also intensify the first visible damage.

The plurality of usage features may further include the cumulative distance for which a vehicle has been driven, the cumulative time duration for which the vehicle has been driven, the parking location of the vehicle, the count of accidents of the vehicle, the acceleration profile of the vehicle, the velocity profile of the vehicle, the braking profile of the vehicle, the count of towing incidents associated the vehicle, and the timestamp of each towing incident associated with the vehicle.

The cumulative distance for which the vehicle has been driven may refer to a total distance traveled by the vehicle after infliction of a visible damage. The cumulative distance may have a direct impact on the visible damage inflicted on the vehicle. The cumulative distance may directly affect severity and intensity of the visible damage inflicted on the vehicle. In an example, a first vehicle may have traveled for 250 kilometers after a visible damage was inflicted on the first vehicle and a second vehicle may have traveled 125 kilometers after a visible damage was inflicted on the second vehicle. Therefore, the visible damage inflicted on the first vehicle may have become more severe than the visible damage inflicted on the second vehicle due to higher usage of the first vehicle. Such severity of the visible damage inflicted on the first vehicle may be a result of environmental and external factors to which the first vehicle may have been subjected to while traveling the cumulative distance of 250 kilometers.

The cumulative time duration for which the vehicle has been driven may refer to a total time for which the vehicle has been driven after infliction of a visible damage. The cumulative time duration may have a direct impact on severity and intensity of the visible damage inflicted on the vehicle. In an example, a first vehicle may have been driven for 100 hours after a visible damage was inflicted on the first vehicle and a second vehicle may have been for 120 hours after infliction of a visible damage. Therefore, the visible damage inflicted on the second vehicle may become more severe than the visible damage inflicted on the first vehicle due to higher driving duration. Such severity of the visible damage inflicted on the second vehicle may be a result of environmental and external factors to which the second vehicle may have been subjected to during the driving time duration.

The parking location of the vehicle may refer to an arrangement and environmental conditions in which the vehicle may have been parked. In an instance, a parking location of the test vehicle 202 may be an open area that may keep the test vehicle 202 exposed to external (e.g., dust, smoke, or the like) as well as environmental conditions. In such an example, one or more factors associated with the parking location of the test vehicle 202 may increase severity of the visible damage caused to the test vehicle 202.

The count of accidents of the vehicle may refer to a number of accidents of the vehicle. The count of accidents may negatively affect or cause the visible damages inflicted to the vehicle. The first processing circuitry 214 may determine the count of accidents associated with the vehicle based on a service log having an entry for repair or maintenance of one or more damages caused to the vehicle during each accident. In an example, the test vehicle 202 may have a count of accidents “5” and the test vehicle 204 may have a count of accidents “10”, after the infliction of a visible damage. In such an example, the visible damage caused to the test vehicle 204 may become severe earlier than the visible damage inflicted on the test vehicle 202 on account of a greater number of accidents.

The acceleration profile of the vehicle may be indicative of information associated with a pattern in which the vehicle is accelerated. The acceleration profile may include time-series of acceleration values of the vehicle. For example, the test vehicle 202 having a visible damage may have been subjected to harsh acceleration and deceleration whereas another test vehicle 204 inflicted with a similar visible damage may have been subjected to smooth acceleration and deacceleration. In such a scenario, the visible damage may of the test vehicle 202 may become more severe as compared to the test vehicle 204. In other words, an acceleration profile of a vehicle directly impacts a visible damage inflicted on the vehicle.

The velocity profile of the vehicle may refer to a range of speed within which the vehicle is driven. In an instance, a vehicle may be driven with a minimum speed of 30 km/hr and a maximum speed of 80 km/hr. Therefore, a velocity profile of the vehicle may indicate that the vehicle may be driven with a velocity ranging between 30 km/hr and 80 km/hr. The vehicle profile that indicates that a difference between the maximum speed with which the vehicle is driven and the minimum speed with which the vehicle is driven is greater than a threshold speed, may have negatively affected the visible damage caused to the vehicle.

The braking profile of the vehicle may be indicative of braking of the vehicle with respect to a speed at which the vehicle was being driven when its brakes were applied. A braking profile that indicates that a vehicle was driven with a speed that is greater than a recommended braking speed when corresponding brakes were applied may negatively impact a visible damage caused to the vehicle.

The count of towing incidents associated with the vehicle may refer to a number of times the vehicle has been towed. The timestamp of each towing incident associated with the vehicle may refer to an exact time and date at which each towing incident associate with the vehicle has occurred. The towing incidents may inflict one or more visible damages to the vehicle or may increase severity of one or more existing visible damages inflicted on the vehicle.

The plurality of usage features may further include the count of historical visible damages inflicted on the vehicle, the position of each historical visible damage inflicted on the vehicle, and the true age of each historical visible damage inflicted on the vehicle.

The count of historical visible damages inflicted on the vehicle may refer to a number of visible damages that have been inflicted on the vehicle in past. The count of historical visible damages may indicate how frequently the vehicle gets damaged. In an example, the test vehicle 202 may have a count of historical damage “5” and the test vehicle 204 may have a count of historical damage “8”. Therefore, a new visible damage inflicted on the test vehicle 204 may be severe than another new damage inflicted on the test vehicle 202 as a higher count of historical visible damage may negatively affect the new visible damage and may result in increased severity of the new visible damage caused to the vehicle.

The position of each historical visible damage inflicted on the vehicle may refer to a component or a position on a component of the vehicle where visible damages may have been inflicted in the past. In an example, multiple occurrences of historical visible damages at a first portion of the test vehicle 202 may be indicative of severity of the visible damage that may have occurred at the first portion of the vehicle. In an exemplary scenario, a visible damage inflicted on a first portion of a vehicle may not be severe. For example, a visible damage caused to a seat of a vehicle may not be severe as compared to a visible damage inflicted on headlight of the vehicle.

The true age of each historical visible damage inflicted on the vehicle may refer to a time interval between a past time-instance at which the historical visible damage was inflicted and the current time-instance.

Subsequently, the first processing circuitry 214 may be further configured to communicate the first plurality of feature values for the plurality of image features and the second plurality of feature values for the plurality of usage features to the second processing circuitry 216. In an embodiment, prior to communicating the first plurality of feature values and the second plurality of feature values to the second processing circuitry 216, the first processing circuitry 214 may be further configured to associate the labels of each image of in the time-series image data with corresponding first plurality of feature values and corresponding second plurality of feature values. For example, as the first plurality of feature values and the second plurality of feature values are determined with respect to each image in the time-series image data, the first processing circuitry 214 may extract the labels (for example, true age label, material type label, damage type label, and intensity label) from each image and associate the extracted labels with the corresponding first plurality of feature values and the corresponding second plurality of feature values. Thus, the first processing circuitry 214 may communicate the first plurality of feature values and the second plurality of feature values along with associated labels to the second processing circuitry 216.

The second processing circuitry 216 may include suitable logic, circuitry, interfaces, and/or code, executable by the circuitry, that may be configured to perform one or more operations for training the plurality of classifiers 116 to assess one or more visible damages caused to vehicles. The second processing circuitry 216 may be an artificial intelligence-based processing circuitry. The second processing circuitry 216 may be configured to train the plurality of classifiers 116 based on the first plurality of feature values, the second plurality of feature values, and associated labels (as represented by dotted box 224).

During training, the first classifier of the plurality of classifiers 116 may be configured to correlate the first plurality of feature values corresponding to the plurality of image features with the known true age of the corresponding visible damage as indicated by the true age label. In other words, the second processing circuitry 216 may be configured train the first classifier to learn and establish a relationship between the first plurality of feature values of each image in the time-series image data and the true age label of the corresponding image. During learning, the first classifier may establish different threshold ranges of the plurality of image features for different true age labels. For example, the first classifier may establish that a count of pixels forming the region of interest may be “1500” when the true age is “one day” and the count of pixels forming may increase to “2000” when the true age is “two days”.

The first classifier of the plurality of classifiers 116 may be further configured to correlate the second plurality of feature values corresponding to the plurality of usage features with the known true age of the corresponding visible damage as indicated by the true age label. In an example, the second plurality of feature values may be indicative of the time-stamp of a towing incident of the test vehicle 202 being one day old. In such an example, the known true age of the visible damage may be “1 day”. Therefore, the first classifier may determine that a towing incident may inflict a visible damage on a vehicle. In such instance, the true age of the visible damage may be in correspondence to the towing incidence.

The first classifier of the plurality of classifiers 116 may be further configured to determine correlation between the first plurality of feature values of the plurality of image features and the second plurality of feature values of the plurality of usage features, for each image in the time-series image data. In an exemplary scenario, the first classifier may determine a rapid increase in size of the region of interest and change in texture of the region of interest for some specific second plurality of feature values. Thus, the first classifier may further determine that corresponding test vehicle may be driven for long hours and in adverse conditions (e.g., high temperature). Further, the first classifier may determine that the known true age of the visible damage may be “2 weeks”. Therefore, the first classifier may correlate the change in texture and size of the region of interest with driving duration and environmental factors associated with usage of the test vehicle with the known true age of the visible damage. In other words, the first classifier may be configured to determine an extent to which a visible damage may get affected by usage pattern of the corresponding vehicle. In other words, the first classifier corelates a look and feel of a visible damage inflicted on a vehicle with the usage pattern of the vehicle and the known true age of the visible damage. The first classifier may be configured to identify changes in the first plurality of feature values corresponding to each image in the time-series image data based on variance in the corresponding second plurality of feature values. Therefore, the first classifier may identify effects of usage of a vehicle on different feature values associated with the image of the visible damage.

Upon training, the first classifier may be configured to generate the first classification output that predicts a true age of a visible damage when inputted with feature values of the plurality of image features and the plurality of usage features pertaining to any target object, such as a vehicle.

During training, the second classifier of the plurality of classifiers 116 may be configured to learn a relationship between the first plurality of feature values and the corresponding material label, with respect to each image in the time-series image data. The material label may indicate a known material category associated with the region of interest of a visible damage. In an example, the first plurality of feature values for a first image in the time-series image data may be indicative of threads, foam, and a coarse texture. Further, the material label associated with the first plurality of feature values may be fabric. Therefore, the second classifier may be configured to learn that features such as thread, foam, and coarse texture may be indicative of the fabric material. In another embodiment, the second classifier may learn a relationship between a component type associated with the visible damage and the material label associated therewith.

Therefore, the second classifier may be configured to associate different components with corresponding material categories. In an example, the component may be a seat of the test vehicle 202, therefore, the second classifier may relate that a material of the seat may be fabric. In another embodiment, the first plurality of feature values (e.g., color intensity) for a second image in the time-series image data may be indicative of rust in a surrounding region of the visible damage. Further, the material label associated with the first plurality of feature values in this scenario may be metal. Therefore, the second classifier may be configured to learn that features such as rust may be indicative of the metal material. Similarly, the second classifier understands the relationship between the first plurality of feature values and the material labels, and may assign different weights to the plurality of image features based on the learning.

Upon training, the second classifier may be configured to generate the second classification output that predicts a material category of a visible damage when inputted with feature values of the plurality of image features pertaining to any target object, such as a vehicle. The predicted material category may be one of the plurality of material categories such as metal (e.g., iron, aluminum, titanium, brass, or the like), plastic, and fabric (cloth, leather, fur, or the like). The plurality of material categories may further include a silicon material, a rubber material, or the like.

During training, the third classifier of the plurality of classifiers 116 may be configured to correlate the first plurality of feature values with the damage label associated with each image of the time-series image data. The damage label may correspond to a type of damage (e.g., dent, crack, scratch, tear, or the like) of the visible damage. The third classifier may be configured to identify, for each image of the time-series image data, the relationship between the first plurality of feature values and the corresponding damage label. In an example, third classifier may learn that when the damage label is a “scratch”, illumination of image pixels forming the region of interest may be higher than illumination of image pixels forming an area surrounding the region of interest. In another example, the third classifier may be configured to learn that when the damage label may be “crack”, illumination of image pixels forming the region of interest may be lower than illumination of image pixels forming an area surrounding the region of interest. Similarly, the third classifier understands the relationship between the first plurality of feature values and the damage labels, and may assign different weights to the plurality of image features based on the learning.

Upon training, the third classifier may be configured to generate the third classification output that predicts a damage category of a visible damage when inputted with feature values of the plurality of image features pertaining to any target object, such as a vehicle. The predicted damage category may be one of the plurality of damage categories such as a crack, a scratch, a dent, a bent, a ding, a tear, or the like.

During training, the fourth classifier of the plurality of classifiers 116 may be configured correlate the first plurality of feature values and an intensity label associated with each image of the time-series image data. The intensity label may refer to a known severity of the visible damage. The fourth classifier may be configured to learn a relationship between the first plurality of feature values of each image in the time-series image data and the corresponding intensity label. In an example, the first plurality of feature values may indicate that in a first image of the time-series image data, a contrast between the region of interest and an area surrounding the region of interest may be low. The fourth classifier may further determine that an intensity label associated with the first image may be low intensity. Thus, the fourth classifier may learn that a low contrast between the region of interest and the area surrounding the region of interest may be associated with low intensity. In another example, the first plurality of feature values may indicate that in a second image of the time-series image data, a contrast between the region of interest and an area surrounding the region of interest may be high. The fourth classifier may further determine that an intensity label associated with the second image may be high intensity.

Thus, the fourth classifier may learn that a high contrast between the region of interest and the area surrounding the region of interest may be associated with high intensity. Similarly, the fourth classifier understands the relationship between the first plurality of feature values and the intensity labels, and may assign different weights to the plurality of image features based on the learning.

Upon training, the fourth classifier may be configured to generate the fourth classification output that predicts an intensity category of a visible damage when inputted with feature values of the plurality of image features pertaining to any target object, such as a vehicle. The plurality of intensity categories may include the high intensity and the low intensity. The predicted intensity category may be one of the plurality of intensity categories such as high intensity, medium intensity, low intensity, or the like.

Examples of the second processing circuitry 216 may include, but are not limited to, an ASIC processor, a RISC processor, a CISC processor, and an FPGA processor. The second processing circuitry 216 may also correspond to a CPU, a GPU, an NPU, or the like. It will be apparent to a person of ordinary skill in the art that the second processing circuitry 216 may be compatible with multiple operating systems. Further, the second processing circuitry 216 may be configured to implement suitable machine-learning techniques, statistical techniques, or probabilistic techniques for training the plurality of classifiers 116 for predicting a true age of a visible damage (e.g., a vehicle damage), a damage category of a vehicle portion that is inflicted with the visible damage, a material category of the portion that is inflicted with the visible damage, and an intensity category of the visible damage. Examples of the plurality of classifiers 116 may include convolutional neural networks, U-Net, Resnet-50, Region-based Convolutional Neural Network (R-CNN), or the like.

In an embodiment, the application server 108 may be configured to test and validate the plurality of classifiers 116. For testing and validation, the first processing circuitry 214 may provide first test feature values of the plurality of image features and second test feature values of the plurality of usage features pertaining to a test image of a visible damage as input to the plurality of classifiers 116. Here, the true age, the damage category, the material category, and the intensity category of the visible damage indicated in the test image are already known. Based on the first test feature values and the second test feature values, the trained first classifier may generate the first classification output. Based on the first test feature values, the trained second through fourth classifiers may generate the second through fourth classification outputs. Based on the first through fourth classification outputs, the second processing circuitry 216 may predict the true age of the visible damage, classify a region of interest associated with the visible damage into a material category, classify the region of interest into a damage category, and classify the region of interest into an intensity category. The second processing circuitry 216 may be further configured to match the predicted true age, the classified material category, the classified damage category, and the classified intensity category with the known true age, the known material category, the known damage category, and the known intensity category, respectively. Based on a deviation between the predicted true age, the classified material category, the classified damage category, and the classified intensity category and the known true age, the known material category, the known damage category, and the known intensity category, respectively, the second processing circuitry 216 may be configured to provide a feedback to each classifier of the plurality of classifiers 116. The plurality of classifiers 116 may be re-trained, based on the received feedback, to improve accuracy thereof. Based on the feedback, the weights assigned by the plurality of classifiers 116 to the plurality of image features and the plurality of usage features are adjusted.

The memory 218 may include suitable logic, circuitry, and interfaces that may be configured to store the trained plurality of classifiers 116 (i.e., the trained first, second, third, and fourth classifiers). The memory 218 may be accessible by the first and second processing circuitry 214 and 216. Examples of the memory 218 may include, but are not limited to, a random access memory (RAM), a read only memory (ROM), a removable storage drive, a hard disk drive (HDD), a flash memory, a solid-state memory, or the like. It will be apparent to a person skilled in the art that the scope of the disclosure is not limited to realizing the memory 218 in the application server 108, as described herein. In another embodiment, the memory 218 may be realized in form of the database server 106 (as shown in FIG. 1) or a cloud storage working in conjunction with the application server 108, without departing from the scope of the disclosure.

The network interface 220 may include suitable logic, circuitry, interfaces, and/or code, executable by the circuitry, that may be configured to enable the first and second processing circuitry 214 and 216 to communicate with the plurality of test vehicles 202-206, the target vehicle 102, and the database server 106. The network interface 220 may be implemented as a hardware, software, firmware, or a combination thereof. Examples of the network interface 220 may include a network interface card, a physical port, a network interface device, an antenna, a radio frequency transceiver, a wireless transceiver, an Ethernet port, a universal serial bus (USB) port, or the like.

It will be apparent to a person skilled in the art that FIG. 2A is exemplary and does not limit the scope of the disclosure. In other embodiments, the application server 108 may be configured to train additional or different classifiers. Further, the application server 108 may include additional or different components for training the plurality of classifiers 116. In other embodiments, the training of the plurality of classifiers 116 may be performed by a processor that is external to the application server 108. In another embodiment, the application server 108 may train one multi-variate neural network that is capable of performing the operations of the first through fourth classifiers.

Referring to FIG. 2B, illustrated is an exemplary embodiment 200B for implementing one or more algorithms for training the plurality of classifiers 116. The plurality of classifiers 116 are trained by implementing a plurality of machine learning algorithms (for example, residual network algorithm, attention network algorithm, or the like). The plurality of classifiers 116 are provided with an input image 226 of the vehicle 102. The input image 226 may be one of the time-series image data. Subsequently, at 228, a convolution operation is performed on the input image 226. During the convolution operation, the input image 226 is divided in to a plurality of sections (as shown by dotted lines in the inputted image 226). Each section may include a plurality of image pixels. Further, the plurality of image pixels of each section of the inputted image 226 may be analyzed during the convolution operation 1. Based on the convolution operation 1, a first plurality of feature maps are generated. Each feature map may correspond to a section of the plurality of sections and may include a matrix of image pixel values corresponding to the section. Subsequently, at 230, a pooling operation is performed on the first plurality of feature maps to generate a pooled feature map and a new image corresponding to the inputted image 226. The new image is generated with an objective to optimally identify the region of interest in the inputted image 226. Further, as shown in FIG. 2B, sequence of convolution operations and pooling operations are performed iteratively till the region of interest is identified and optimally presented in the new image generated during the pooling operation. A count of iterations of convolution and pooling operations performed for training the plurality of classifiers 116 may be based on convolution operations and pooling operations required for optimally identifying the region of interest. In an embodiment, the convolution operation and the pooling operation may be modified to include or exclude one or more attributes, features, or calculation to improve corresponding efficiency.

Further, an area vector 232 associated with the visible damage may be inputted during a convolution operation n (at 234). The area vector 232 may be indicative of one of a dimension of the visible damage and a portion (e.g., length, breadth, area, diameter, or the like) of the vehicle 102 that may have the visible damage. The area vector 232 may be determined based on a median of the plurality of intensity categories (e.g., high intensity category, low intensity category, moderate intensity category, or the like). The area vector 232 inputted during the convolution operation may enable the plurality of classifiers 116 to determine the intensity category of the visible damage. The area vector 232 may be updated periodically or based on change in median of the plurality of intensity categories. Such update of the area vector 232 may enable the plurality of classifiers 116 to learn and improve based on a change in type of visible damage, attributes/factors affecting the visible damage, change in data associated with the visible damage. Beneficially, such update of the area vector 232 significantly resolves “cold start problem” faced by the plurality of classifiers 116. The “cold start problem” may refer to failure in identifying or analyzing the visible damage accurately due to a reduction in the median or in cases of small images depicting severe damages.

Subsequently, at 236, a pooling operation n is performed and one or more outputs are generated. The one or more outputs may include an image of the region of interest 238, the predicted intensity category 240, the predicted damage category 242, the predicated material category 244, and the predicted true age of the visible damage 246. The image of the region of interest 238, the predicted intensity category 240, the predicted damage category 242, the predicated material category 244, and the predicted true age of the visible damage 246 is matched with region of image, intensity category, damage category, material category, and true age tagged with the inputted image 226.

It will be apparent to a person skilled in the art that FIG. 2B is exemplary and does not limit the scope of the disclosure.

FIG. 3A is a schematic diagram that illustrates an exemplary environment for prediction of the true age of the visible damage inflicted on the target vehicle, in accordance with an exemplary embodiment of the disclosure. Referring to FIG. 3A, the exemplary environment 300A includes the target vehicle 102 and corresponding imaging device 104. The exemplary environment further includes the application server 108.

During the implementation mode, the first processing circuitry 214 may be configured to receive one or more images of the visible damage 114 inflicted on the target vehicle 102. The first processing circuitry 214 may receive the images of the visible damage 114 from the imaging device 104 associated with the target vehicle 102. The received image(s) may include the portion of the target vehicle 102 that is inflicted with the visible damage 114. The one or more images may be captured by the imaging device 104 at the first time-instance (e.g., the current time-instance). The first processing circuitry 214 may be further configured to receive the second time-series information from the target vehicle 102. The second time-series information may be indicative the usage pattern of the target vehicle 102.

The first processing circuitry 214 may be configured to recognize the region of interest in the received image (as shown with a dotted box 302). The region of interest may correspond to the portion of the target vehicle 102 that is inflicted with the visible damage 114. In an embodiment, the first processing circuitry 214 may be configured to recognize the region of interest based on one or more image identification techniques and/or one or more image processing techniques. For example, the region of interest may be identified based on one of a feature-based approach and an object-based approach. Various techniques (e.g., feature based approach and object-based approach) of identifying the region of interest in an image may be known in the art. In an example, the region of interest may be identified by way of a bounding box technique or hierarchical region-of-interest detection (HROID) algorithm.

Subsequently, the first processing circuitry 214 may be configured to determine the third plurality of feature values for the plurality of image features based on the recognized region of interest. The first processing circuitry 214 may determine the third plurality of feature values (as shown by a dotted box 304) based on analysis of value of each image pixel of the one or more images. In an example, a size of the region of interest may be determined based on a difference in intensity, illumination, or saturation of image pixels that form the region of interest and intensity, illumination, or saturation of image pixels that surround the region of interest. Further, the first processing circuitry 214 may be configured to determine the fourth plurality of feature values (as shown by the dotted box 304) for the plurality of usage features. In an example, the count of maintenance and repair incidents may be determined based on the service log of the target vehicle 102. In another example, the count of historical visible damages inflicted on the target vehicle 102 may be determined by way of a maintenance log associated with the target vehicle 102.

Further, the first processing circuitry 214 may be configured to communicate the determined third plurality of features and the fourth plurality of features to the trained first classifier (hereinafter, the trained first classifier 306) executed by the second processing circuitry 216. The trained first classifier 306 may be configured to generate the first classification output. The first classification output may be determined based on the learnt correlation between the third plurality of feature values, the fourth plurality of feature values, and the true age of visible damages.

In an embodiment, the trained first classifier 306 may analyze the region of interest that includes the visible damage 114 as well as an area that surrounds the visible damage 114 based on the third plurality of feature values. In an example, the trained first classifier 306 may determine that a visible damage may be new based on edges of the visible damage being sharp. In another example, the trained first classifier 306 may determine that the visible damage may be new based on dirt build-up on the visible damage combined with a dull appearance of the visible damage.

In an embodiment, the trained first classifier 306 may take into consideration the first damage category, the first material category, and the first intensity category associated with the region of interest while generating the first classification output. In an instance, when the first material category may be plastic, the trained first classifier 306 may determine that a visible damage having a sharp finish may be new and another visible damage having a dull finish may be old. Further, the trained first classifier 306 may also determine that a visible damage having fresh debris around it may be new. In an example, the second classification output may be indicative of the region of interest being fabric. In such an example, the trained first classifier 306 may determine that a tear in fabric with rough edges, fabric coming out, visible foam and may have dust deposition on the visible foam. Therefore, the trained first classifier 306 may predict that the visible damage 114 may be old.

The second processing circuitry 216 may be configured to predict the true age (as shown by a dotted box 308) of the visible damage 114 inflicted to the target vehicle 102 based on the first classification output of the trained first classifier 306. Here, the true age indicates an exact age of the visible damage 114, for example, one week old, two weeks old, one month old, or the like.

Further, the first processing circuitry 214 may be configured to communicate, via the network interface 220, the predicted true age of the visible damage 114 to a user device (e.g., driver device of the driver) associated with the target vehicle 102 or the imaging device 104 to render the true age of the visible damage 114 on a user interface of the user device (e.g., cell phone, laptop, smart-watch, or the like).

FIG. 3B is a schematic diagram that illustrates an exemplary environment for classification of the region of interest into the first material category, in accordance with another exemplary embodiment of the disclosure. Referring to FIG. 3B, the exemplary environment 300B includes the target vehicle 102 and corresponding imaging device 104. The exemplary environment 300B further includes the application server 108.

The first processing circuitry 214 may be configured to determine the third plurality of feature values for the plurality of image features based on the recognized region of interest (as shown by a dotted box 310). Recognition of the region of interest has been described in the foregoing description of FIG. 3A. The first processing circuitry 214 may be configured to provide the third plurality of feature values to the trained second classifier (hereinafter, referred to and designated as “the trained second classifier 312”).

The trained second classifier 312 may be configured to generate the second classification output based on the received third plurality of feature values. The second classification output may be indicative of a material of the portion of the target vehicle 102 on which the visible damage 114 is inflicted. In an example, the visible damage 114 may refer to a tear in a front tire of the target vehicle 102. In such an example, the material on which the visible damage 114 is inflicted may be rubber. The second classification output in such an example may be indicative of the material being rubber. In another example, the visible damage 114 may be inflicted on a seat of the target vehicle 102. In such an example, the material on which the visible damage 114 is inflicted may be fabric (e.g., cloth, rubber, rexine, polyurethane leather, or the like). The second classification output in such an example may be indicative of the material being fabric.

Subsequently, the second processing circuitry 216 may be configured to classify the region of interest into the first material category (as shown within dotted box 314) of the plurality of material categories based on the second classification output generated by the trained second classifier 312. The first material category may be one of metal, plastic, rubber, fabric category. In an example, the second classification output may be indicative of the material being fabric. In such an example, the second processing circuitry 216 may be configured to classify (e.g., predict) the region of interest in the fabric category.

Further, the first processing circuitry 214 may communicate, via the network interface 220, the first material category of the region of interest to the user device (e.g., driver device of the driver) associated with the target vehicle 102 or the imaging device 104 to render the first material category of the region of interest on the user interface of the user.

FIG. 3C is a schematic diagram that illustrates an exemplary environment for classification of the region of interest into the first damage category, in accordance with another exemplary embodiment of the disclosure. Referring to FIG. 3C, the exemplary environment 300C includes the target vehicle 102 and the corresponding imaging device 104. The exemplary environment 300C further includes the application server 108. As described in conjunction with FIGS. 3A and 3B, the first processing circuitry 214 may be configured to determine the third plurality of feature values for the plurality of image features based on the recognized region of interest. The first processing circuitry 214 may be configured to provide the third plurality of feature values to the trained third classifier (hereinafter, referred to and designated as “the trained third classifier 316”).

The trained third classifier 316 may be configured to receive the third plurality of feature values from the first processing circuitry 214. The trained third classifier 316 may be configured to generate the third classification output indicative of the first damage category of the region of interest having the visible damage 114. The trained third classifier 316 may be configured to determine a type the visible damage 114 inflicted on the target vehicle 102. The type of the visible damage 114 may be a dent, a ding, a scratch, a tear, or the like. As shown, the visible damage 114 may be caused to an outer body of the target vehicle 102. Therefore, the trained third classifier 316 may determine that a type of the visible damage 114 may be a scratch. In an example, the visible damage 114 may be caused to a seat of the target vehicle 102. In such an example, the type of the visible damage 114 may be a tear. The trained third classifier 316 may be further configured to communicate the third classification output to the second processing circuitry 216.

Subsequently, the second processing circuitry 216 may be configured to classify the region of interest into the first damage category of the plurality of damage categories based on the third classification output generated by the trained third classifier 316 (as shown by a dotted box 318). The second processing circuitry 216 may classify the region of interest into one of a crack, a scratch, a dent, a tear, or a ding category. In an example, the third classification output may be indicative of the type of the visible damage 114 being a scratch. In such an example, the second processing circuitry 216 may be configured to classify (e.g., predict) the region of interest in the first damage category i.e., the scratch.

Further, the first processing circuitry 214 may communicate, via the network interface 220, the predicted damage category of the region of interest to the user device (e.g., driver device of the driver) associated with the target vehicle 102 or the imaging device 104 to render the damage category of the region of interest on the user interface of the user device.

FIG. 3D is a schematic diagram that illustrates an exemplary environment for classification of the region of interest into the first intensity category, in accordance with another exemplary embodiment of the disclosure. Referring to FIG. 3D, the exemplary environment 300D includes the target vehicle 102 and corresponding imaging device 104. The exemplary environment 300D further includes the application server 108. As described in conjunction with FIG. 3B, the first processing circuitry 214 may be configured to determine the third plurality of feature values for the plurality of image features. The first processing circuitry 214 may be configured to provide the third plurality of feature values to the trained fourth classifier (hereinafter, referred to and designated as “the trained fourth classifier 320”).

The trained fourth classifier 320 may be configured to receive the third plurality of feature values. The trained fourth classifier 320 may be further configured to analyze and process the third plurality of feature values to generate the fourth classification output. The fourth classification output may be indicative of intensity of the visible damage 114 inflicted on the target vehicle 102. The trained fourth classifier 320 may be configured to analyze illumination of each pixel of the region of interest to determine the intensity of the visible damage 114 based on the third plurality of feature values. In an embodiment, the trained fourth classifier 320 may be configured to determine the intensity of the visible damage 114 based on a contrast between a first set of image pixels forming the region of interest and a second set of image pixels forming its surrounding.

In an embodiment, each classifier may be configured to take a classification output of another classifier as input. Similarly, the trained fourth classifier 320 may be configured to take the second classification output of the trained second classifier 312 as input. In an example, the second classification output may be indicative of the region of interest being fabric. In such an example, the trained fourth classifier 320 may determine that a tear in fabric with rough edges, fabric coming out, and visible foam may be indicative of high intensity of the visible damage 114.

The trained fourth classifier 320 may be further configured to communicate the generated fourth classification output to the second processing circuitry 216. Subsequently, the second processing circuitry 216 may be configured to classify the region of interest into the first intensity category of the plurality of intensity categories (as shown within a dotted box 322) based on the fourth classification output generated by the trained fourth classifier 320. The first intensity category may be one of the high intensity and the low intensity category. In an example, the third classification output may be indicative of the damage being a scratch. In such an example, the second processing circuitry 216 may be configured to classify (e.g., predict) the region of interest in the low intensity category. In another example, the fourth classification output may be indicative of the damage being a tear in a tire of the target vehicle 102. In such an example, the second processing circuitry 216 may be configured to classify (e.g., predict) the region of interest in the high intensity category.

Further, the first processing circuitry 214 may communicate, via the network interface 220, the predicted intensity category of the region of interest to the user device (e.g., driver device of the driver) associated with the target vehicle 102 or the imaging device 104 to render the intensity category of the region of interest on the user interface of the user device.

In an embodiment, the first processing circuitry 214 may be further configured to predict the RUL of the portion of the target vehicle 102 that has been inflicted by the visible damage 114.

The first processing circuitry 214 may predict the RUL based on the predicted true age, the first damage category, the first intensity category, and the first material category. In another embodiment, the first processing circuitry 214 may predict the RUL based on the predicted true age and the first intensity category. In an example, the visible damage 114 may have a true age of 2 days and the first intensity category may be high intensity. In such an example, the RUL of the portion of the target vehicle 102 having the visible damage 114 may be less as compared to another portion having visible damage that is 2 days with low intensity.

In another embodiment, the first processing circuitry 214 may predict the RUL by correlating the predicted true age, the predicted damage category, the predicted intensity category, and the predicted material category with historical incidents of similar visible damages having similar true age, intensity category, damage category, and intensity category and corresponding actual remaining life. For example, if a historical visible damage having the true age, the intensity category, the damage category, and the intensity category similar to the predicted true age, the predicted damage category, the predicted intensity category, and the predicted material category, respectively, required replacement or repair after 3 weeks, the RUL predicted by the first processing circuitry 214 may be 3 weeks for the visible damage 114.

Each classifier of the plurality of classifiers 116, during the implementation mode, may perform a sequence of convolution operation and pooling operation iteratively for predicting the true age 308, the first material category 314, the first damage category 318, and the first intensity category 322.

FIGS. 4A and 4B are schematic diagrams that, collectively, illustrate an exemplary scenario for rendering predicted information via the user interface of the user device associated with the target vehicle, in accordance with an exemplary embodiment of the disclosure. The predicated information may include the predicted true age, the first damage category, the first intensity category, the first material category, and the predicted RUL. Referring to FIG. 4A, illustrated is an exemplary scenario 400A that includes the target vehicle 102 and corresponding imaging device 104. The exemplary scenario 400A further includes the application server 108 having the processing circuitry 112 (e.g., the first processing circuitry 214 and the second processing circuitry 216).

As shown in the exemplary scenario 400A, the target vehicle 102 may have the visible damage 114 inflicted on its outer body. At least one image of the visible damage 114 may be captured via the imaging device 104. Referring now to FIG. 4B, illustrated is the captured image 402 of the target vehicle 102. Referring back to FIG. 4A, the imaging device 104 may be configured to communicate the captured image 402 to the processing circuitry 112 as soon as the image 402 gets captured or when prompted by the application server 108. The captured image 402 may be time-stamped to indicate a time instance when the image 402 was captured.

The processing circuitry 112 may receive the image 402 communicated by the imaging device 104. The processing circuitry 112 may be configured to receive second time-series information indicative of the usage pattern of the target vehicle 102 from the database server 106, the memory 218, or any other device or server that stores vehicle level information of the target vehicle 102. Further, the processing circuitry 112 may determine the region of interest in the received image 402. Referring again to FIG. 4B, the image 402 may include the region of interest 404 that includes the portion of the target vehicle 102 that has been inflicted with the visible damage 114.

Referring back to FIG. 4A, the processing circuitry 112 may be configured to process the image 402 to determine the third plurality of feature values for the plurality of image features. The processing circuitry 112 may be further configured to process the second time-series information to determine the fourth plurality of feature values for the plurality of usage features. Further, the processing circuitry 112 may provide the third and fourth plurality of feature values to the trained first classifier 306. The trained first classifier 306 may generate the first classification output. The processing circuitry 112 may be further configured to provide the third feature values to the trained second classifier 312, the trained third classifier 316, and the trained fourth classifier 320. The trained second classifier 312 may generate the second classification output.

The trained third classifier 316 may generate the third classification output. The trained fourth classifier 320 may generate the fourth classification output. Further, the processing circuitry 112 may be configured to predict the true age of the visible damage 114 based on the first classification output. The processing circuitry 112 may be further configured to classify the region of interest 404 of the image 402 into the first material category based on the second classification output. The processing circuitry 112 may be further configured to classify the region of interest 404 of the received image 402 into the first damage category based on the third classification output. The processing circuitry 112 may be further configured to classify the region of interest 404 of the received image 402 into the first intensity category based on the fourth classification output. Moreover, the processing circuitry 112 may be configured to predict the RUL of the portion of the target vehicle 102 having the visible damage 114. Subsequently, the processing circuitry 112 may communicate the predicted true age, the first damage category, the first intensity category, the first material category, and the predicted RUL to the imaging device 104 and render the user interface on the imaging device 104 to present the predicted true age, the first damage category, the first intensity category, the first material category, and the predicted RUL. As shown via the imaging device 104, the first damage category may be “Scratch”, the first material category may be “Fabric”, the first intensity category may be “High intensity”. Further, as shown, the predicted true age may be “2 weeks” and the predicted RUL may be “2 months”.

It will be apparent to a person skilled in the art that the user interface presented by way of the imaging device 104 is exemplary and does not limit the scope of the disclosure.

In an embodiment, the plurality of classifiers 116 may be implemented locally on an imaging device or a user device by way of a mobile or web application hosted by the application server 108, without deviating from the scope of the disclosure.

FIG. 5 is a block diagram that illustrates a system architecture of a computer system 500 for implementing the damage assessment method, in accordance with an exemplary embodiment of the disclosure. An embodiment of the disclosure, or portions thereof, may be implemented as computer readable code on the computer system 500. In one example, the processing circuitry 112 or the database server 106 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6, 7A, and 7B. The computer system 500 may include a processor 502, a communication infrastructure 504, a main memory 506, a secondary memory 508, an input/output (I/O) port 510, and a communication interface 512.

The processor 502 that may be a special purpose or a general-purpose processing device. The processor 502 may be a single processor or multiple processors. The processor 502 may have one or more processor “cores.” Further, the processor 502 may be coupled to the communication infrastructure 504, such as a bus, a bridge, a message queue, the communication network 110, multi-core message-passing scheme, or the like. Examples of the main memory 506 may include RAM, ROM, and the like. The secondary memory 508 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The I/O port 510 may include various input and output devices that are configured to communicate with the processor 502. Examples of the input devices may include a keyboard, a mouse, a joystick, a touchscreen, a microphone, and the like. Examples of the output devices may include a display screen, a speaker, headphones, and the like. The communication interface 512 may be configured to allow data to be transferred between the computer system 500 and various devices that are communicatively coupled to the computer system 500. Examples of the communication interface 512 may include a modem, a network interface, i.e., an Ethernet card, a communication port, and the like. Data transferred via the communication interface 512 may be signals, such as electronic, electromagnetic, optical, or other signals as will be apparent to a person skilled in the art. The signals may travel via a communications channel, such as the communication network 110, which may be configured to transmit the signals to the various devices that are communicatively coupled to the computer system 500. Examples of the communication channel may include a wired, wireless, and/or optical medium such as cable, fiber optics, a phone line, a cellular phone link, a radio frequency link, and the like. The main memory 506 and the secondary memory 508 may refer to non-transitory computer readable mediums that may provide data that enables the computer system 500 to implement the methods illustrated in FIGS. 6, 7A, and 7B.

FIG. 6 is a flowchart that illustrates a method for training the plurality of classifiers for damage assessment of vehicles, in accordance with an exemplary embodiment of the disclosure.

Referring to FIG. 6, there is shown a flowchart 600 that illustrates exemplary operations 602 through 610 for training the plurality of classifiers 116 for damage assessment of vehicles.

At 602, the time-series image data of at least one test vehicle (e.g., one of the plurality of test vehicles 202-206) that targets the portion of test vehicle inflicted with visible damage is received. The processing circuitry 112 is configured to receive the time-series image data of the test vehicle of the plurality of test vehicles 202-206. Each image in the time-series image data targets the portion of the test vehicle that is inflicted with the visible damage. The time-series image data is received for the first-time duration (e.g., the training time-interval) that may range from the second time-instance when the visible damage 114 may have been inflicted on the test vehicle to the third time-instance.

At 604, for each image in the time-series image data, the first plurality of feature values for the plurality of image features is determined. The processing circuitry 112 may be configured to determine, for each image in the time-series image data, the first plurality of feature values for the plurality of image features.

At 606, the first time-series information that indicates the usage pattern of the test vehicle during the first-time duration may be retrieved. The processing circuitry 112 may be configured to retrieve the first time-series information that indicates the usage pattern of the test vehicle during the first-time duration from one of the database server 106, or the local memory of the target vehicle 102.

At 608, the second plurality of features values for the plurality of usage features may be determined based on the retrieved first time-series information. The processing circuitry 112 is configured to determine the second plurality of feature values for the plurality of usage features based on the retrieved first time-series information.

At 610, the plurality of classifiers 116 are trained using the first plurality of feature values and the second plurality of features values to learn the relationship of true age, intensity, damage category, and surface material of visible damage with the first plurality of feature values and second plurality of feature values. The processing circuitry 112 may be configured to train the plurality of classifiers 116 using the first plurality of feature values and the second plurality of features values to learn the relationship of true age, intensity, damage category, and surface material of visible damage with the first plurality of feature values and the second plurality of feature values. The trained plurality of classifiers 116 are used to predict the true age of the visible damage 114 inflicted on the target vehicle 102 based on an image that captures the visible damage 114 and second time-series information that indicates the usage pattern of the target vehicle 102.

FIGS. 7A and 7B, collectively, represent a flowchart that illustrates the damage assessment method, in accordance with an exemplary embodiment of the disclosure. Referring to FIGS. 7A and 7B, there is shown a flowchart 700 that illustrates exemplary operations 702 through 718 for damage assessment of vehicles.

At 702, the image that displays the portion of the target vehicle 102 inflicted with the visible damage 114 may be received. The processing circuitry 112 is configured to receive the image that displays the portion of the target vehicle 102 inflicted with the visible damage 114.

At 704, the region of interest in the image may be recognized such that the region of interest corresponds to the portion of the target vehicle 102 that is inflicted with the visible damage 114. The processing circuitry 112 is configured to recognize the region of interest in the received image that has the target vehicle 102 displayed therein. The region of interest corresponds to the portion of the target vehicle 102 in the image that is inflicted with the visible damage 114. The image is captured by the imaging device 104 at the first-time instance. The first-time instance may correspond to the current time-instance.

At 706, the third plurality of feature values for the plurality of image features may be determined based on the recognized region of interest. The processing circuitry 112 may be configured to determine the third plurality of feature values for the plurality of image features based on the recognized region of interest.

At 708, the second time-series information that indicates the usage pattern of the target vehicle 102 may be retrieved from the memory (e.g., the database server 106 or the local memory of the target vehicle 102). The processing circuitry 112 may be configured to retrieve the second time-series information that indicates the usage pattern of the target vehicle 102 from the memory (e.g., the database server 106 or the local memory of the target vehicle 102).

At 710, the fourth plurality of feature values for the plurality of usage features may be determined based on the retrieved time-series information. The processing circuitry 112 may be configured to determine the fourth plurality of feature values for the plurality of usage features based on the retrieved second time-series information.

Referring now to FIG. 7B, at 712, the third and fourth plurality of feature values may be provided as input to the trained plurality of classifiers 116. The processing circuitry 112 may be configured to provide the third and fourth plurality of feature values as the input to the trained plurality of classifiers 116.

At 714, the first damage category of the visible damage 114, the first surface material of the visible damage 114, the first intensity category of the visible damage 114, and the true age of the visible damage 114 may be predicted based on the first, second, third, and fourth classification output of the trained first, second, third, and fourth classifiers respectively. The processing circuitry 112 may be configured to predict the first damage category of the visible damage 114, the first surface material category of the visible damage 114, the first intensity category of the visible damage 114, and the true age of the visible damage 114 based on the first, second, third, and fourth classification output of the first, second, third, and fourth classifiers, respectively.

At 716, the RUL of the portion of the target vehicle 102 that is inflicted with the visible damage may be predicted based on the predicted true age of the visible damage 114, the first intensity category into which the region of interest is classified, the first damage category into which the region of interest is classified, and the first material category into which the region of interest is classified. The processing circuitry 112 is configured to predict the RUL of the portion of the target vehicle 102 that is inflicted with the visible damage 114 based on the predicted true age of the visible damage 114, the first intensity category into which the region of interest is classified, the first damage category into which the region of interest is classified, and the first material category into which the region of interest is classified.

At 718, the user interface of the imaging device 104 may be rendered to present the predicted RUL, the true age, the first intensity category, the first damage category, and the first material category. The processing circuitry 112 may be configured to render the user interface of the imaging device 104 to present the predicted RUL, the true age, the first intensity category, the first damage category, and the first material category.

Various embodiments of the disclosure provide the processing circuitry 112 for implementing the damage assessment system. The processing circuitry 112 may be configured to receive the image of the target vehicle 102 that presents the portion of the target vehicle 102 that is inflicted with the visible damage 114. The processing circuitry 112 may be configured to recognize the region of interest in the received image that has the target vehicle 102 displayed therein. The region of interest corresponds to the portion of the target vehicle 102 in the image that is inflicted with the visible damage 114. The image is captured by the imaging device 104 at the first-time instance. The processing circuitry 112 may be further configured to determine the third plurality of feature values for the plurality of image features based on the recognized region of interest. The processing circuitry 112 may be further configured to retrieve, from the memory, the time-series information that indicates the usage pattern of the target vehicle 102. The processing circuitry 112 may be further configured to determine the second plurality of feature values for the plurality of usage features based on the retrieved time-series information. The processing circuitry 112 may be further configured to provide the first plurality of feature values and the second plurality of feature values as input to the trained first classifier 306. The processing circuitry 112 may be further configured to predict the true age of the visible damage 114 based on the first classification output of the trained first classifier 306 for the first plurality of feature values and the second plurality of feature values. The true age indicates the time duration between the first-time instance and the historical time instance at which the target vehicle 102 was inflicted with the visible damage 114. The processing circuitry 112 may be further configured to provide the third plurality of feature values as the input to the trained second classifier 312. The processing circuitry 112 may be further configured to classify the region of interest into the first material category of the plurality of material categories based on the second classification output of the trained second classifier 312 for the third plurality of feature values.

The processing circuitry 112 may be further configured to provide the third plurality of feature values as the input to the trained third classifier 316. The processing circuitry 112 may be further configured to classify the region of interest into the first damage category of the plurality of damage categories based on the third classification output of the trained third classifier 316 for the third plurality of feature values. The processing circuitry 112 may be further configured to provide the third plurality of feature values as the input to the trained fourth classifier 320. The processing circuitry 112 may be further configured to classify the region of interest into the first intensity category of the plurality of intensity categories based on the fourth classification output of the trained fourth classifier 320 for the third plurality of feature values.

Various embodiments of the disclosure provide a non-transitory computer readable medium having stored thereon, computer executable instructions, which when executed by a computer, cause the computer to execute one or more operations for training the plurality of classifiers 116 for performing damage assessment of vehicles. The one or more operations include receiving, by the processing circuitry 112, the time-series image data of at least one test vehicle of the plurality of test vehicles 202-206. Each image in the time-series image data targets the portion of the test vehicle that is inflicted with the visible damage. The time-series image data is received for the first-time duration that begins from the time instance of infliction of the visible damage on the test vehicle. The one or more operations further include determining, by the processing circuitry 112, for each image in the time-series image data, the first plurality of feature values for the plurality of image features. The one or more operations further include retrieving, by the processing circuitry 112, from the memory, the first time-series information that indicates the usage pattern of the test vehicle during the first-time duration. The one or more operations further include determining, by the processing circuitry 112, the second plurality of feature values for the plurality of usage features based on the retrieved first time-series information. The second plurality of feature values is determined with respect to each image in the time-series image data. The one or more operations further include training, by the processing circuitry 112, at least one of the first, second, third, and fourth classifiers using the first plurality of feature values and the second plurality of feature values to learn the relationship between the true age of the visible damage, the first plurality of feature values, and the second plurality of feature values. The trained first, second, third, and fourth classifiers are used to predict the true age of the visible damage inflicted on the target vehicle 102 based on the image that captures the visible damage 114 and second time-series information that indicates the usage pattern of the target vehicle 102.

Various embodiments of the disclosure provide a non-transitory computer readable medium having stored thereon, computer executable instructions, which when executed by a computer, cause the computer to execute one or more operations for implementing the damage assessment method. The one or more operations include recognizing, by the processing circuitry 112, the region of interest in the image that has the target vehicle 102 displayed therein. The region of interest corresponds to the portion of the target vehicle 102 in the image that is inflicted with the visible damage 114. The image is captured by the imaging device 104 at the first-time instance. The one or more operations further include determining, by the processing circuitry 112, the third plurality of feature values for the plurality of image features based on the recognized region of interest. The one or more operations further include retrieving, by the processing circuitry 112, from the memory, the second time-series information that indicates the usage pattern of the target vehicle 102. The one or more operations further include determining, by the processing circuitry 112, the fourth plurality of feature values for the plurality of usage features based on the retrieved second time-series information. The one or more operations further include providing, by the processing circuitry 112, the third plurality of feature values and the fourth plurality of feature values as the input to the trained first classifier 306. The one or more operations further include predicting, by the processing circuitry 112, the true age of the visible damage 114 based on the first classification output of the trained first classifier 306 for the third plurality of feature values and the fourth plurality of feature values. The true age indicates time duration between the first-time instance and historical time instance at which the target vehicle 102 was inflicted with the visible damage 114. The one or more operations further include providing, by the processing circuitry 112, the third plurality of feature values as input to the trained second classifier 312. The one or more operations further include classifying, by the processing circuitry 112, the region of interest into the first material category of the plurality of material categories based on the second classification output of the trained second classifier 312 for the third plurality of feature values. The plurality of material categories includes metal, plastic, and fabric. The one or more operations further include providing, by the processing circuitry 112, the third plurality of feature values as input to the trained third classifier 316. The one or more operations further include classifying, by the processing circuitry 112, the region of interest into the first damage category of the plurality of damage categories based on the third classification output of the trained third classifier 316 for the third plurality of feature values.

The plurality of damage categories includes the crack, the scratch, and the dent. The one or more operations further include providing, by the processing circuitry 112, the third plurality of feature values as input to the trained fourth classifier 320. The one or more operations further include classifying, by the processing circuitry 112, the region of interest into the first intensity category of the plurality of intensity categories based on the fourth classification output of the trained fourth classifier 320 for the third plurality of feature values. The plurality of intensity categories includes the high intensity and the low intensity. The one or more operations further include predicting, by the processing circuitry 112, the RUL of the portion of the target vehicle 102 based on the predicted true age of the visible damage 114 and the first intensity category into which the region of interest is classified.

The disclosed embodiments encompass numerous advantages. Exemplary advantages of the disclosed methods include, but are not limited to, damage assessment of vehicles. The disclosed methods and systems allow for assessment of the visible damage 114 inflicted on the target vehicle 102 without a need for physical inspection of the visible damage 114. The disclosed methods and systems allow for the prediction of the true age of the visible damage 114 based on the image of the target vehicle 102 having the visible damage 114. Such prediction of true age may establish authenticity and legitimacy of the visible damage that may be beneficial in determining eligibility of the target vehicle 102 for insurance claims. Further, the disclosed methods and systems also allow for the prediction of material category, intensity category, and damage category associated with the visible damage. Such prediction may allow an owner of the target vehicle 102 to make a decision regarding maintenance and repair of the target vehicle 102. Further, the disclosed methods and systems allow for the prediction of the RUL of the portion of the target vehicle 102 having the visible damage 114. Determination of RUL enables the owner of the target vehicle 102 to timely schedule the maintenance and repair of the target vehicle 102.

Therefore, the disclosed methods and systems significantly reduce a probability of sudden breakdown of the target vehicle 102 and hence preventing financial loss that could be caused due to the sudden breakdown of the target vehicle 102. Moreover, the disclosed methods and systems are easy to implement using existing technology and may not require a user to make any complex and advanced modification. Hence, the disclosed methods and systems provide for a user-friendly solution for remotely assessing the visible damage 114 caused to the target vehicle 102 thereby saving time and cost required for physically inspecting the visible damage 114.

The present disclosure may be implemented in numerous application areas. For example, the disclosed method and system may be utilized by a towing agency to inspect various damages inflicted on a vehicle when an owner of the vehicle claims that the damages are inflicted during a towing incident of the vehicle. In another example, a transportation service provider that rents out the vehicles may use the disclosed method and system to inspect vehicles upon return. In another example, an insurance agency may use the disclosed method and system to inspect vehicles for insurance claims.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the scope of the disclosed subject matter.

Techniques consistent with the disclosure provide, among other features, damage assessment systems, damage assessment methods, and methods for training classifiers for performing damage assessment of vehicles. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

What is claimed is:

1. A damage assessment method, comprising:
recognizing, by processing circuitry, a region of interest in an image that has a target object displayed therein, wherein the region of interest corresponds to a portion of the target object in the image that is inflicted with a visible damage, and wherein the image is captured by an imaging device at a first-time instance;
determining, by the processing circuitry, a first plurality of feature values for a plurality of image features based on the recognized region of interest;
retrieving, by the processing circuitry, from a memory, time-series information that indicates a usage pattern of the target object;
determining, by the processing circuitry, a second plurality of feature values for a plurality of usage features based on the retrieved time-series information;
providing, by the processing circuitry, the first plurality of feature values and the second plurality of feature values as input to a trained first classifier; and
predicting, by the processing circuitry, a true age of the visible damage based on a first classification output of the trained first classifier for the first plurality of feature values and the second plurality of feature values, wherein the true age indicates a time duration between the first-time instance and a historical time instance at which the target object was inflicted with the visible damage.

2. The damage assessment method of claim 1, further comprising receiving, by the processing circuitry, the image of the target object from a memory or over a communication network.

3. The damage assessment method of claim 1, further comprising:
providing, by the processing circuitry, the first plurality of feature values as input to a trained second classifier; and
classifying, by the processing circuitry, the region of interest into a first material category of a plurality of material categories based on a second classification output of the trained second classifier for the first plurality of feature values, wherein the plurality of material categories includes metal, plastic, and fabric.

4. The damage assessment method of claim 1, further comprising:
providing, by the processing circuitry, the first plurality of feature values as input to a trained third classifier; and
classifying, by the processing circuitry, the region of interest into a first damage category of a plurality of damage categories based on a third classification output of the trained third classifier for the first plurality of feature values, wherein the plurality of damage categories includes a crack, a scratch, and a dent.

5. The damage assessment method of claim 1, further comprising:
providing, by the processing circuitry, the first plurality of feature values as input to a trained fourth classifier; and
classifying, by the processing circuitry, the region of interest into a first intensity category of a plurality of intensity categories based on a fourth classification output of the trained fourth classifier for the first plurality of feature values, wherein the plurality of intensity categories includes a high intensity and a low intensity.

6. The damage assessment method of claim 5, further comprising predicting, by the processing circuitry, a remaining useful life of the portion of the target object based on the predicted true age of the visible damage and the first intensity category into which the region of interest is classified.

7. The damage assessment method of claim 1, wherein the plurality of image features includes a count of image pixels associated with the region of interest, a size of the recognized region of interest, a diameter of the visible damage in the recognized region of interest, a contrast between the region of interest and a surrounding surface of the region of interest in the received image, and a texture of the region of interest.

8. The damage assessment method of claim 7, wherein the plurality of image features further includes a relative distance of the region of interest from another visible damage in a surrounding region of the region of interest and a type of component of the target object associated with the region of interest.

9. The damage assessment method of claim 1, wherein the usage pattern of the target object indicates one or more external and environmental conditions to which the target object has been exposed during a use of the target object and one or more object handling attributes of the target object, and wherein the time-series information includes time-series values of each of the one or more external and environmental conditions and the one or more object handling attributes.

10. The damage assessment method of claim 1, wherein the plurality of usage features includes a temperature, humidity, rain, an altitude, and a friction coefficient to which the target object has been exposed.

11. The damage assessment method of claim 1, wherein the plurality of usage features includes a count of different users that have used the target object, a count of washing incidents associated with the target object, a count of maintenance and repair incidents of the target object, and a frequency of breakdown of the target object.

12. The damage assessment method of claim 1, wherein the target object is a vehicle.

13. The damage assessment method of claim 12, wherein the plurality of usage features includes a cumulative distance for which the target object has been driven, a cumulative time duration for which the target object has been driven, a parking location of the target object, a count of accidents of the target object, an acceleration profile of the target object, a velocity profile of the target object, a braking profile of the target object, a count of towing incidents associated with the target object, and a timestamp of each towing incident.

14. The damage assessment method of claim 1, wherein the plurality of usage features further includes a count of historical visible damages inflicted on the target object, a position of each historical visible damage, and a true age of each historical visible damage.

15. A method, comprising:
receiving, by processing circuitry, time-series image data of at least one test vehicle, wherein each image in the time-series image data targets a portion of the test vehicle that is inflicted with a visible damage, and wherein the time-series image data is received for a first-time duration that begins from a time instance of infliction of the visible damage on the test vehicle;
determining, by the processing circuitry, for each image in the time-series image data, a first plurality of feature values for a plurality of image features;
retrieving, by the processing circuitry, from a memory, first time-series information that indicates a usage pattern of the test vehicle during the first-time duration;
determining, by the processing circuitry, a second plurality of feature values for a plurality of usage features based on the retrieved first time-series information, wherein the second plurality of feature values is determined with respect to each image in the time-series image data; and
training, by the processing circuitry, a classifier using the first plurality of feature values and the second plurality of feature values to learn a relationship between a true age of the visible damage, the first plurality of feature values, and the second plurality of feature values, wherein the trained classifier is used to predict a true age of a visible damage inflicted on a target vehicle based on an image that captures the visible damage and second time-series information that indicates a usage pattern of the target vehicle.

16. The method of claim 15, wherein the usage pattern of the target vehicle indicates one or more external and environmental conditions to which the target vehicle has been exposed during a use of the target vehicle and one or more object handling attributes of the target vehicle, and wherein the second time-series information includes time-series values of each of the one or more external and environmental conditions and the one or more vehicle handling attributes.

17. A damage assessment system, comprising:
processing circuitry configured to:
recognize a region of interest in an image that has a target vehicle displayed therein, wherein the region of interest corresponds to a portion of the target vehicle in the image that is inflicted with a visible damage, and wherein the image is captured by an imaging device at a first-time instance;
determine a first plurality of feature values for a plurality of image features based on the recognized region of interest;
retrieve, from a database, time-series information that indicates a usage pattern of the target vehicle;
determine a second plurality of feature values for a plurality of usage features based on the retrieved time-series information;
provide the first plurality of feature values and the second plurality of feature values as input to a trained first classifier; and
predict a true age of the visible damage based on a first classification output of the trained first classifier for the first plurality of feature values and the second plurality of feature values, wherein the true age indicates a time duration between the first-time instance and a historical time instance at which the target vehicle was inflicted with the visible damage.

18. The damage assessment system of claim 17, wherein the processing circuitry is further configured to:
provide the first plurality of feature values as input to a trained second classifier; and
classify the region of interest into a first intensity category of a plurality of intensity categories based on a second classification output of the trained second classifier for the first plurality of feature values, wherein the plurality of intensity categories includes a high intensity and a low intensity.

19. The damage assessment system of claim 17, wherein the plurality of image features includes two or more of a count of image pixels associated with the region of interest, a size of the recognized region of interest, a diameter of the visible damage in the recognized region of interest, a contrast between the region of interest and a surrounding surface of the region of interest in the received image, a texture of the region of interest, a relative distance of the region of interest from another visible damage in a surrounding region of the region of interest, and a type of component of the target vehicle associated with the region of interest.

20. The damage assessment system of claim 17, wherein the plurality of usage features includes two or more of a count of different users that have used the target vehicle, a count of washing incidents associated with the target vehicle, a count of maintenance and repair incidents of the target vehicle, a frequency of breakdown of the target vehicle, a cumulative time duration for which the target vehicle has been driven, a parking location of the target vehicle, a count of accidents of the target vehicle, an acceleration profile of the target vehicle, a velocity profile of the target vehicle, a braking profile of the target vehicle, a count of towing incidents associated with the target vehicle, a timestamp of each towing incident, a count of historical visible damages inflicted on the target vehicle, a position of each historical visible damage, and a true age of each historical visible damage.
